(19) United States
(12) Patent Application Publication
(10) Pub. No.: US 2021/0370210 A1
(43) Pub. Date: Dec. 2, 2021

(54) FILTER MEDIUM, MATERIALS AND METHODS FOR THE REMOVAL OF CONTAMINANTS

(71) Applicant: Klaus Gottschall, Heddesheim (DE)

(72) Inventors: Klaus Gottschall, Heddesheim (DE); Evelyn Gottschall, Heddesheim (DE); Peter Pfeuffer, Ketsch (DE)

(21) Appl. No.: 17/286,677

(22) PCT Filed: Oct. 18, 2019
(86) PCT No.: PCT/EP2019/078394

§ 371 Date: Apr. 19, 2021

(30) Foreign Application Priority Data
Oct. 19, 2018 (EP) 18201392.0

(51) Int. Cl. B01D 46/00; B01D 39/16; B01D 39/20

(52) U.S. Cl. CPC B01D 46/0001; B01D 39/163; B01D 2239/1233; B01D 2257/91; B01D 2239/0407; B01D 39/2017

(57) ABSTRACT

Filter media, filter elements, and arrangements of filters, wherein at least one polymeric mesh adsorbent is comprising at least one functional polymer or derivative of a functional polymer, capable of binding contaminants from a gas mixture, preferably proteins, peptides, glycoproteins, lipoproteins, nucleic acids, carbohydrates, and lipids. These contaminants may exhibit allergenic or toxic properties. These contaminants are preferably embedded in aerosols or attached to small particles. Processes for the synthesis of a polymeric mesh, whereas at least one functional polymer is immobilized via generation of amide or ester bonds, whereas all reactants are not activated and not comprising active groups.

### TECHNICAL FIELD

The present invention relates to methods for the removal of contaminants from a substance mixture, preferably from a gas, using a polymeric mesh, comprising at least one immobilized adsorbing polymer.

The present invention also relates to the synthesis of a polymeric mesh, whereas at least one functional polymer is immobilized to a surface via amide or ester bonds, reacting at least two not activated compounds.

The present invention also relates to a filter arrangement, a filter element, or a filter medium comprising at least one immobilized and adsorbing polymer or a derivative thereof.

### BACKGROUND OF THE INVENTION

The occurrence of organic contaminants in the air and in aqueous solutions is a severe menace for human health and for the environment. Allergenic, toxic, harmful, in general hazardous substances are raising increasing problems in many respects. In particular, the removal of low concentrated biological substances from large volume streams, both liquid and gaseous, is still a significant technical problem. Although filter systems are available removing very efficiently micro-organisms, no satisfactory solutions are available so far to bind the degradation products of such cells. With increasing service time of filter systems the potential impact of such degradation products includes a severe risk for human health.

Critical substances are comprising active biological molecules, but also the reaction products of such molecules, inclusive the necrotic load stemming from cells, mainly from plants, like pollen, or from micro-organisms, like fungi, bacteria, viruses, or parasites.

One major problem are the various hazardous, but mainly unknown compounds released after the disintegration, death or degradation of organisms. Such substances are often exhibiting allergenic properties, but may also provide a harmful, even toxic impact.

Filter techniques using nanoparticles, e.g. silver, in order to kill any micro-organisms may increase the depletion problems, as they produce death organisms, but do not offer a solution to bind the related degradation products.

In general does germ degradation occur over the lifetime of filters independently of their composition or design.

The chemical nature of potentially harmful substances of biological origin, deriving from plant seeds or other living or death cells is comprising mainly proteins, peptides, glycoproteins, lipoproteins, nucleic acids like DNA or RNA, as well as carbohydrates like poly(saccharides), lipids, or combinations thereof.

Contaminants of the present application are preferably comprising substances with a molecular weight between 100 Da and 5 million Da, viruses or fragments deriving from germs are even bigger. The molecular sizes of said contaminants are typically ranging from 0.5 nm to several μm. Class of impurities or contaminants means a number of compounds which are chemically related.

Said contaminants are mostly air born, e.g. transported by the wind, often embedded or incorporated in mist, or in aerosols, as well as associated with small particles like soot or fine dust from combustion processes, even in the form of nanoparticles. Accordingly those carriers, in particular aerosols and small particles are also comprised by the contaminant definition of the present application.

The usual technologies for the removal of air contaminants, impurities, or degradation products are filtration, adsorption and washing, or a combination thereof. Adsorption means the binding of molecules using an adsorbent, whereas binding comprises any kind of non-covalent interaction. The term chemisorption is often used for a very strong, even covalent binding of said substances.

Apparently the broad structural variety of these contaminants did not allow solutions with broad applicability so far.

Thus the design, development and production of effective adsorbents applicable for the removal of undesired compounds remains an important task throughout the adsorption and filtration industries. In particular, the design of materials with broad applicability would be of high value.

Targeting the removal of such mostly organic contaminants, it is the object of the present invention to provide suitable materials, manufacturing processes for said materials, and procedures for the application of said materials.

These objects are accomplished according to the present invention by: A method for the removal of contaminants from a substance mixture, preferably at least one of the abovementioned contaminants, more preferably from a gas, using a polymeric mesh adsorbent, comprising at least one immobilized adsorbing polymer, wherein said at least one polymer is retaining at least one of said contaminants.

A process for the equipment of threads and particles, preferably for the synthesis of a filter medium, comprising at least one polymeric mesh adsorbent, whereas at least one functional polymer is immobilized or attached to a surface via amide or ester bonds, reacting at least two not activated compounds, thus generating the adsorptive layer.

A filter arrangement, a filter element, or a filter medium comprising a polymeric mesh adsorbent, comprising at least one immobilized and adsorbing polymer or a derivative thereof.

A “polymeric mesh adsorbent” of the present application is either a “porous polymeric gel” or a composite material, comprising a support material and at least one immobilized porous polymeric coating. In contrast, a gel is comprising at least one at least partially porous solid polymer without support material.

The porosity of the polymer is preferably generated by the space available inside and between the immobilized coils and globules. Preferred materials are in both cases functional polymers and co-polymers, also comprising related derivatives, wherein at least one functional group is bearing a ligand or residue.

Immobilized means that the polymeric mesh adsorbent is not soluble under the conditions of application, preferably achieved by means of non co-valent or co-valent attachment to a surface, by means of cross-linking, by means of low solubility in the solvents applied, or by a combination of said procedures and properties.

The fibrous substrate capable of binding or embedding said polymeric gels can be made from natural and/or synthetic fibres with woven and/or non-woven structures.

In particular, the object of the present invention is comprising the development of gas filtration processes and the related materials. Such gas filtration processes are preferably comprising air filtration for HVAC (heating ventilation air conditioning) systems, ventilation of automotive passenger cabins, removal of waste compounds, hazardous gas components from intake or exhaust filtration systems. The removal of undesirable organic material is of interest not only in air filtration, but also for the purification of process gases, e.g. biogas, and is thus object of the present invention.

Additional challenges in gas filtration are mainly related to the diversity of the various products and procedures applied with air filtration and air conditioning processes, comprising a wide range of different mass products and devices, including filters for cars and vacuum cleaners, but also complex filter systems for hospitals or sky scrapers. Gas means preferably air and products of air processing.

Gas filters are usually comprising one or more layers of fabric, tissue or nonwovens which may be further equipped with at least one adsorptive coating. The manufacturing process is consisting of at least two steps. The first step is the production of the base material in an continuously working woven or nonwoven line, treating large volumes of product, usually as roll material, within a rather short time at a high throughput. The second step is comprising the equipment with the particular adsorbent. Further steps may comprise the combination of the base material with additional layers, e.g. microfiber or membrane filter layers. The final step is comprising the entire process of the base material treatment and converting in order to produce an applicable filter element.

With respect to the embodiments and the explanations of the present application the following definitions are used in order to describe materials or products for filtration purposes:

Filter medium, plural filter media, means the material or substance, which is, as a composite, equipped with said immobilized porous polymeric coating, or is entirely consisting of the adsorptive polymer (“porous polymeric gel”). Accordingly filter medium is a technical synonym for the chemical term “polymeric mesh adsorbent”. The filter medium is a composite material in most cases. The filter medium is the substance or material taking over the separation function, by removal the contaminants according to the above and below embodiments and explanations. The preferred filter medium is a polymeric mesh, either an at least in part porous polymeric gel, or a composite material comprising an at least in part porous polymer.

A filter element is describing a design, forming a manageable and applicable unit out of the filter medium. Filter elements can be combined which each other and/or with usual filtration devices, depending on the filtration application and arranged in series or in parallel.

Filter arrangements are combinations of at least two filters, whereas at least one is comprising a filter element equipped with a filter medium.

For filter manufacturing several more detailed tasks are resulting, however, beyond designing surfaces with high affinity towards contaminants:

For the purpose of fabric, tissue, membrane or nonwovens treatment a rapid general method of finishing or coating is desirable, preferably using fast reactions at enhanced temperature, preferably in aqueous solutions or starting from aqueous solutions, suspensions, or emulsions, more preferred in a dry or molten state.

The resultant products of the equipment or finishing of fabric, tissue, membranes, and other filter materials as well as the potential reaction products of the related support materials should be chemically and mechanically stabile during the whole manufacturing process as well as in long-term applications.

Producing the final filter element, the base material including the polymeric mesh needs to withstand the various impacts during the industrial converting steps from filter media to the ready-made filter element e.g. mechanical forces like cutting, stamping, pleating and welding. The adsorptive layers need to be sealed with filter frame components to avoid leakages between the contaminated and clean compartments of the filter cases.

With respect to an effective simultaneous depletion of a broad range of contaminants, preferably concerning substances of biological origin, it was hardly possible to maintain these above manufacturing goals and conditions using the prior art chemistry and technology of fibre treatment and filter production, as it will be explained in more detail below.

For these aforesaid reasons another task of the present application is relating to solutions for the problem of manufacturing large quantities of various chemically equipped fabrics, applying a robust and simple chemistry, while preferably using the existing procedures and devices at the production site.

Moreover these products and the related manufacturing and application processes should be environmentally friendly, always based on an acceptable energy and materials consumption. In particular hazardous reagents, side products and emissions should be avoided.

Thus, the task is also related to the application of water soluble, at least water-miscible, non harmful starting materials.

### PRIOR ART

In the past, the purpose of fabric finishing was mainly an improvement of the utilisation properties, e.g. to achieve a water repelling or iron-free equipment of garments. Additional objects were and remain the generation of antistatic, lipophobic, flame retardant, or bactericide features.

Another application field of growing importance are filtration procedures targeting the depletion of undesired compounds from a liquid or gas phase, either using porous particles or tissue-based adsorbents. The relating products have mostly been dedicated to the removal of low molecular mass compounds:

Examples are the removal of waste/flue gases or bad smelling gas components from intake air filtration systems such as automotive passenger cabins or general HVAC systems for residential areas, offices, workshops, passenger busses, or ships.

The removal of corrosive components like sulphur dioxide and nitrous gases from intake air or other process gases remains also an important field in filtration technology.

Common adsorption media for this purpose are activated carbon without or with additional chemical equipment for acid or basic gases, silica gels, or porous pellets equipped with potassium permanganate or potassium hydroxide. Usually the pore size of said filtration media is too small for the binding of organic molecules with high molecular mass.

Other undesired items are comprising micro organisms like parasites, fungi, bacteria or viruses, but also allergenic, harmful, and toxic substances. In the meantime the removal of related degradation products, mainly necrotic contaminants deriving from micro-organisms is of growing interest, while no general solution available for this serious problem.

For the removal of microorganisms filter applications comprising silver or nano silver coatings of filter fibers are already in use. The silver is of bactericide effect, however bacterial decomposition products, containing allergenic of even toxic compounds to a significant degree, can be released during the filter lifetime and thus threaten people breathing the air behind said filters. In addition, the silver is still actively killing bacteria, even when the filter is disposed at its lifetime in any landfill, or even in rivers, where the silver does not distinguish between pathogens and helpful germs.

For the removal of such a hazardous contaminant variety from a gas stream a sufficient binding capacity of a filter, combined with satisfactory depletion capability (affinity) towards the numerous undesired compounds of mostly unknown structure would be requisite. However, not many attempts have been made so far in order offer products of broad and selective applicability in air filtration.

Therefore another object of the present invention is to provide adsorbents exhibiting high partitioning coefficients (definitions below) and binding capacities towards a big number of substances with various chemical structures or molecular epitopes.

For air filtration purposes several equipped tissues are known from the prior art, whereas the coating is mostly attached via non-covalent forces.

One example is EP 3 162 425, disclosing a filter medium for the deactivation of allergenic compounds, comprising an acid-functionalized layer, whereas citric acid is one of the preferred acids. The target was thus not to adsorb said allergenic compounds, nor other hazardous compounds, obviously the majority is only denatured or otherwise converted.

EP 2 948 191 discloses an air filter system binding odorant and noxious molecules in the cavity of cyclodextrins, cucurbiturils, and calixarenes. In one embodiment the filter agent was impregnated with a poly(vinylamine) covalently derivatized with cyclodextrine. The impurities were specifically bound inside the cavity of the cyclic ligand, thus retaining low molecular mass molecules. EP 2 948 191 did not recognize the depletion capabilities of polyamines and other functional polymers, in particular not the affinity towards macromolecules of biological origin.

In addition, the application of polyamines is known for the deactivation of microorganisms. EP 1 879 966 discloses the use of a cationic polymer as a biocidal active substance in solution. The polymer is preferably poly(ethyleneimine) or poly(vinylamine).

Several attempts have been made for the preparation of selective nano-porous polymeric adsorbents, capable of interaction with various molecules in a liquid solution or suspension. The porosity, surface area and the pore size distribution are critical parameters with respect to the targeted depletion properties, mainly application scope, selectivity and binding capacity of an adsorbent.

Polymeric meshes were usually designed by cross-linking of functional polymers (see e.g. EP 1 232 018).

A variety of cross-linkers was applied for the immobilisation of polyamines, favourably dialdehydes, bis-epoxides and activated bivalent carboxylic acids.

In a few cases the desired binding behaviour of said polymeric meshes was created by the attachment of appropriate ligands, selected from a broad variety of compounds (U.S. Pat. No. 9,061,267).

Those materials have been used for adsorption purposes in the liquid phase, mainly in chromatography, e.g. for the purification of high-value substances achieved by the separation from impurities contained in raw reaction solutions. Interestingly they have not been applied so far for the removal of substances from the gas phase.

These composite adsorbents are preferably comprising a particulate support material, more preferably silica gel, wherein the pores are filled with a cross-linked amino polymer.

Various routes of amide or ester formation are known, preferably starting from carboxylic acid derivatives and amines, respectively alcohols (see e.g. Jerry March, Advanced Organic Chemistry, McGRAW-HILL, ISBN 0-07-085540-4). Targeting amides, the acids are usually activated, halogenides, anhydrides, and azides are common activated compounds. For more ambitious purposes, the comprehensive activation chemistry of peptide synthesis is available (see below).

For the application of active (e.g. acid chlorides) or activated (e.g. with carbonyl diimidazole CDI, N-hydroxy succinimide, (NHS) derivatives) reagents, aprotic organic solvents are obligatory.

“Active” reagent means that the compound will spontaneously undergo a reaction without preliminary treatment, either with an electrophilic or a nucleophilic partner at preferably ambient, at least moderate temperatures below 40° C. “Activated” means that the reagent is prepared as an intermediate from less reactive compound like carboxylic acids, converting to radicals which finally remain part of the product. Using these active or activated reagents, an aqueous solvent or even water traces will at least reduce the yield, generate side products, or may even inhibit the reaction at all.

Accordingly there is a considerable synthesis and engineering effort using this kind of chemistry. Usually such reagents will not match the requirements of a continuous bulk manufacturing process, on particular not the existing technology of fabric finishing, although they may be suitable in special cases. However, the related costs are high, normally only acceptable for the manufacturing of special chromatographic adsorbents, e.g. suitable for the purification of high-end products like peptides.

The solution of the problem(s) to be solved by the present invention is defined in the appended claims. Herein, claims 1 to 9 relate to a method of removing a contaminant from a gas or from a liquid or a gas, claims 10 to 22 to a filter medium, claim 22 to a combination of filter media, claims 23 and 24 to a wet-laid process of making a filter medium, claims 25 to 26 to a process of making a polymeric mesh, claim 27 to a polymeric mesh, claim 28 to a filter medium comprising a polymeric mesh, claims 29 to 39 to a process for the production of a filter medium, claims 40 to 43 to a filter element comprising a filter medium, and claim 44 to a filter arrangement comprising a filter element as defined therein.

### General Description

### Main Compounds and Methods

Different to those abovementioned high-end processes, usually no target compound is to be isolated in gas phase applications. Rather the permanent adsorption of the undesired compounds remains the only, but challenging goal.

In one preferred embodiment, in combination with any of the above and below embodiments, the gas is air, either static or flowing.

This reduction of the purpose does not imply any simplification of the task, however, also because the manufacturing processes of said adsorbents for biopolymer purification and the handling of the related ingredients are often complicated, hardly to be implemented to continuous large scale manufacturing processes of fabric bulk commodities.

According to the present invention it has been possible to solve the abovementioned problems, and the respective objects were achieved providing a polymeric mesh adsorbent comprising particles, membranes, monoliths, or threads finished or equipped with at least one contaminants binding functional polymer, and preferably combining said polymeric mesh adsorbent, called filter medium in the context of gas filtration, with at least one additional device, component or building block, alternatively machine, or treat said polymeric mesh, thus forming at least one filter element, or combining such filter elements with additional filtration devices in order to make a filter arrangement.

At least one additional part, in combination with the filter element or arrangement of the present application, is e. g. comprising one filtration device, mechanically retaining particles, micro-organisms, germs or pollen, preferably a microfilter, ultrafilter or a combination of both.

Composite materials are comprising at least one support material and at least one polymeric filler, layer, network, or coating, at least in part being porous.

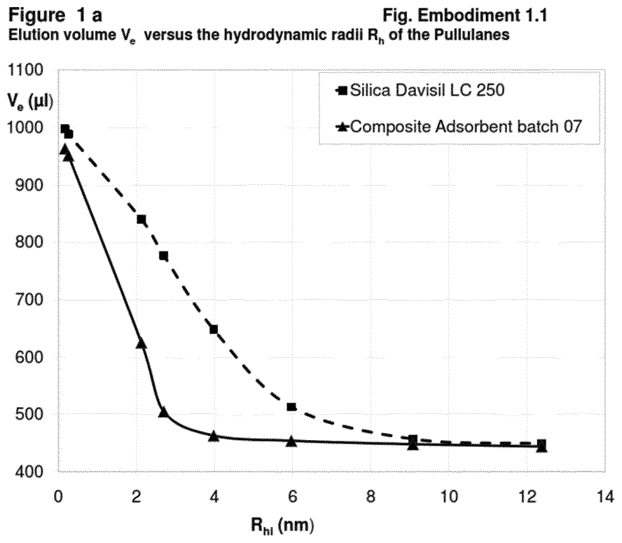

Porous means that there is a volume available inside the polymeric coils or globules accessible for pullulane standards with a hydrodynamic radius Rₕ of at least 0.5 nm, as determined when dissolved and measured under inverse size exclusion chromatography (iSEC) conditions in 20 mM ammonium acetate at pH 6 (see Methods and FIG. 1).

In combination with any of the above or below embodiments, the present application is providing methods for the synthesis and the use of a polymeric mesh exhibiting an upper, but variable pore size Rₕᵢ, thus capable of retaining a significant amount of compounds with a hydrodynamic radius below this exclusion limit Rₕᵢ (nm) inside the pore volume, preferably 50%, more preferred 80%, most preferred >90% of the initial content. The main parameters controlling Rₕᵢ, are the structure of the functional polymer, the nature of the cross-linker, the degree of cross-linking, and, in the case of particulate composites also the pore size distribution of the support material.

The polymer gels and the composite materials of the present application are comprising at least one immobilized, contaminant binding polymer. The composite materials are preferably made from a support material, either tissue, monolithic materials like membranes, or particles by coating with a functional, preferably contaminant binding polymer.

Filter medium, preferably comprising a carrier or support material and an adsorptive polymeric coating, is another term for a polymeric mesh adsorbent, preferably a composite material of the present application, when used for filtration purposes. Other examples of a polymeric mesh adsorbent are gel particles made from the adsorbing polymer itself.

Filter elements of the present application are preferably comprising the polymeric mesh and at least one additional component, layer or segment, not bearing said at least one adsorptive polymer, but serving for other purposes, preferably capable of mechanical filtration and/or mechanical support or simply enabling the applicability.

Therefore, the present invention is related to

filter media, filter elements, and arrangements of filters,
wherein at least one polymeric mesh adsorbent is comprising at least one functional polymer or derivative of a functional polymer, capable of binding contaminants. Preferred contaminants are proteins, peptides, glycoproteins, lipoproteins, nucleic acids like DNA or RNA, as well as carbohydrates like poly(saccharides), lipo poly(saccharides), other lipids or combinations thereof, e.g. stemming from the degradation of germs or from potentially allergenic sources like pollen or animal excrements.

Also preferred are contaminants embedded in aerosols or attached to small particles like dust. When dissolved or embedded in an aerosol, said contaminants preferably exhibit approximately a hydrodynamic radius ranging from Rₕ=0.25 nm up to several 100 nm, including viruses or fragments thereof.

Most preferred are substances either with proven or with potential allergenic and toxic properties.

In addition, germs like bacteria, fungi, spores, pollen, viruses, cells, or fragments thereof are also examples of preferred contaminants.

Contaminants of the present application are preferably comprising substances with a molecular mass between 100 Da and 5 mio Da.

Bacteriae or fragments generally deriving from germs or cells are usually bigger, not characterized by a molecular mass, the molecular sizes of such contaminants are typically ranging from a 5 nm diameter to several μm.

Impurity is a synonymous term for contaminant. Class of impurities or contaminants means a number of compounds which are chemically related.

The functional polymers of the present application may also be derivatized, i.e. bearing a ligand or residue, bound to at least one of its monomer units comprising at least one functional group. Said ligand may be attached to the polymer using preferably polymer-analogous reactions. Alternatively, the residue may be already part of the polymer, ab initio generated during the polymer synthesis like the formyl groups of poly(vinylformamide-co-vinylamine).

The molecular mass of a radical of said ligands is preferably below 1000, more preferred below 500, most preferred below 300. Radical means the residue of a derivatisation reagent incorporated to the final polymer after the reaction, respectively the radical replacing at least one hydrogen atom from the functional group of a polymer. Accordingly, the maximal molecular mass of a monomer unit is preferably below 1200, more preferably below 700, most preferred below 500.

In preferred embodiments, in combination with any of the above and below embodiments, the at least one polymeric mesh adsorbent or filter medium is either a part of a filter, of a filter element, and of an arrangement of filters, preferably dedicated to gas filtration. In one preferred embodiment, in combination with any of the above and below embodiments, the gas is air, either static or flowing.

Therefore is the present invention related to a

combination of a at least one polymeric mesh adsorbent with at least one component not involved to the binding process, thus forming a filter element,
characterized in that the functional polymer forming the polymeric mesh is comprising monomer units exhibiting a molecular mass not above 1200 Da.

Moreover is the present invention related to

filter media, filter elements, and arrangements of filters,
wherein at least one polymeric mesh adsorbent is comprising at least one functional polymer or derivative of a functional polymer comprising monomer units exhibiting a molecular mass not above 1200 Da.

The following are main embodiments with respect to the application of a polymeric mesh.

The present invention is also related to

a method for the removal of contaminants from a liquid or gaseous substance mixture, preferably from a gas,
using at least one filter, filter element, or filter arrangement, comprising at least one polymeric mesh adsorbent,
wherein said at least one polymeric mesh adsorbent, comprising at least one immobilized functional polymer, is retaining at least one of said contaminants.

Accordingly, the present invention is related to a method for the removal of contaminants from a gas or a mixture of several gases, using at least one polymeric mesh adsorbent,

wherein at least one immobilized functional polymer as a part of said at least one polymeric mesh is retaining at least one of said contaminants.

Accordingly, the present invention is related to a method for the removal of contaminants from a gas or a mixture of several gases, wherein at least one immobilized functional polymer is retaining at least one of said contaminants.

### Polymers

For the purpose of the present application any polymer or co-polymer is basically applicable for designing a polymeric mesh. Even lipophilic polymers like poly(propylene) undergo derivatisation reactions, e.g. after treatment by etching or irradiation.

The relating polymer is either soluble in aqueous or organic liquids, and capable of derivatisation and cross-linking reactions. A polymer suspension, preferably when dissolving during these chemical steps is considered also applicable for the purpose of the present invention.

In combination with any of the above or below embodiments, the average molecular weight of the polymer is preferably 500 to 2,000,000 Dalton, more preferably 5,000 to 1,000,000 Dalton, even more preferably 15,000 to 400,000 Dalton, most preferred 20,000 to 200,000 Dalton.

In a preferred embodiment, in combination with any of the below embodiments, the cross-linkable polymers or co-polymers, preferably the individual molecules are comprising at least one functional group (a “functional polymer”). The term functional polymer is extended by definition to any derivatives of a functional polymer. Also mixtures of polymers, comprising at least one molecule bearing a functional group, are within this definition.

Optionally said functional polymers are also subject to further derivatisation.

The following embodiments are listing several functional polymers serving for the creation of a polymeric mesh, preferably providing starting materials for the design of composites when attached to one or more support materials and subsequently derivatized.

Numerous additional combinations are possible according to the principles and rules as given with the present application, as established within the above and below embodiments, also comprising any combination with the comprehensive prior art synthesis methods, as known to a skilled person.

In further preferred embodiments, in combination with any of the above and below embodiments, derivatives of said functional polymers are applied for designing the polymeric mesh.

In preferred embodiments, in combination with any of the above or below embodiments, the contaminants binding compound of the present application is comprising at least one immobilized basic, acidic, or neutral functional polymer, preferably a polysulphonic or polyphosphonic compound, a polythiol, more preferably a polyamine, a polycarboxylate, or a polyalcohol, or a combination of at least two functional polymers.

Any functional polymer may also comprise at least two different functional groups.

Immobilization means that the polymer is fixed to the support surface and/or in the support pore after treatment with the solvents used for washing, equilibration, and cleaning, and thus preferably will not be removed during the application of the composite.

In a preferred embodiment, in combination with any of the above or below embodiments, the functional polymer itself and the depleted contaminants are sufficiently fixed to the surface of the filter medium, not being able to be removed during the entire filtration process, preferably including the dismounting of the filter element, and even when the filter is disposed in any landfill.

Co-polymers, poly-condensation products (e.g. peptides and other polyamides), and oligomers or molecules with at least four equal or different repetitive units are considered within the polymer definition for the present invention. Preferred co-polymers are comprising at least one poly(vinylpyrrolidon) or poly(vinylacetate) unit.

Basic polymers are preferably poly amines, more preferred: poly(vinylformamide-co-vinylamine); linear or branched poly(vinylamine), poly(allylamine), and poly(ethyleneimine), poly-lysine, poly(vinylimidazol), polypyrrol, polyaniline; or copolymers containing such amino polymers.

Preferred acidic polymers and the relating salts are poly(acrylate), poly(methacrylate), poly(styrene sulphonate), poly(vinyl sulphonate), poly(phosphonates), poly(itaconic acid), poly(phosphates), poly(aspartic acid) and their co-polymers.

### Support Materials

The support materials are preferably comprising any kind of tissue or fabric, either woven or non-woven, or a monolithic backbone, or a membrane, or are comprising porous or non-porous particles, or any combination of at least two different of these material categories.

Support materials may be either porous or non-porous, or may be a combination of both. The form of the porous support material is not particularly limited.

Any support material can be used for the preparation of the composite materials of the present application, provided that at least a first polymer immobilized to the support surface remains stable under the conditions of preparation, rinsing, cleaning and most importantly application.

The following support materials are examples of suitable starting or raw materials for the synthesis of filter media (polymeric mesh adsorbents) of the present application, and can be equipped with said adsorptive polymer. This selection is comprising examples and not considered complete, other materials as known to a skilled person, may also be applicable as a support.

Fabrics made of

synthetic fibers from preferably poly(ester), poly(olefine), poly(amide), poly(acrylonitrile), poly(phenylensulfide), pol(yimide), aramide, poly(vinylamine), poly(vinyliden-fluoride);
natural fibers such as wool, cotton, cellulose, amylose, or chitosan;
mineral fibers like glass, micro-glass, ceramic.

The fabric filter media as described above can be carried out as

nonwovens, e.g. staple fibers, needle felts with or without scrim, wet laid nonwoven, spun bond nonwoven, melt blown nonwoven;
woven fabrics or knitted fabrics, or combinations out of both aforesaid variants.

The fabric filter support material can also consist of a combination comprising at least two of the aforesaid variants.

Granulate, powder or pellets (particulate materials), either porous or non-porous, e.g. comprising activated carbon, silica gel, zeolite, diatomaceous earth, other ceramic compound like alumina oxide, or comprising organic e.g. ion exchanger resin, and any mixture or combination of foresaid compounds.

In preferred embodiments, in combination with any of the above or below embodiments, such particulate materials can be combined with fabric filter media, e.g. by sticking on or by embedding in between two or more fabric layers or even by mixing it into single fabric layers between the single fibers.

### Other Support Materials

like synthetic membranes or foils, ceramic honey combs, porous sponges on a synthetic, ceramic or natural (biologic) base, porous plate, cylinders or other geometric shapes made of sintered granulates which can be passed through by air.

Further on it is possible to combine at least two of the above and below materials and media, generating a kind of multi layered sandwich structure, which can be varied depending on the filtration task.

For additional preferred embodiments comprising support materials see below. Monolithic support materials are also applicable. Monolithic means a homogeneously porous piece of support material exhibiting a thickness of at least 0.5 mm, preferably made from silica, alumina, zirconia, steel (e.g. a porous frit), or poly(acrylate). In a further preferred embodiment, in combination with any of the above or below embodiments, the monolithic support material is a disk, a torus, a cylinder or a hollow cylinder, with at least 0.5 mm height and with an arbitrary diameter.

Pellicular materials are also within the scope of the present invention. They exhibit a solid core and a porous surface or external layer. Some pellicular materials are commercially available comprising threads or solid particles coated with a porous layer.

### Immobilization

Among the available methods of polymer immobilisation cross-linking is preferred. The polymer immobilization may be also achieved by covalent binding to the support material, or by precipitation or adsorption, or by any other form of deposition from a solution, suspension or emulsion.

In preferred embodiments, in combination with any of the above or below embodiments, the total amount of polymer immobilized to a support material is between 0.1% and 1000% of the support weight, more preferred between 1% and 100%, most preferred between 5% and 50%.

The degree of cross-linking for a polymeric mesh synthesized for the purpose of the present application should preferably not exceed 50%. Preferred are 2% to 40%, more preferred 5% to 30%, most preferred are 10% to 20%.

The degree of cross-linking is calculated from the equivalent weight of the cross-linker applied, relating to the equivalents of the functional groups available in the related batch. E.g. using a bivalent cross-linker the molar amount is divided by two, in order to obtain the degree of cross-linking (20 mole equivalents are thus generating a 10% nominal degree of cross-linking, see also Example 1).

In combination with any of the above or below embodiments, any cross-linker known from prior art is applicable for the immobilization of a polymer according to the present invention.

The cross-linker may either be introduced together with the polymer, in order to allow for a simultaneous reaction of both, or the cross-linking reaction may be carried out separately, in a subsequent step (see also the Chapter “Amide Formation” below).

The cross-linker should preferably represent the chemically active or activated reagent in the formation of the polymeric mesh.

Alternatively, the polymer may be introduced as the chemically activated partner, using the reagents and procedures as known from the prior art, in particular from peptide synthesis.

The polymer may also a priori be reactive. In this case functional groups of the polymer may be generated during the cross-linking process itself or subsequently, applying reactive or activated polymers, e.g., anhydrides from poly(maleic acid), or poly-oxiranes.

### Derivatisation

The functional polymer of the present application may also be derivatized. The degree of derivatisation is between 0.5% and 100%, preferably between 10% and 90%. Cross-linking is considered a special embodiment of derivatisation.

Any synthesis steps within the present patent application may be carried out according to the various methods and protocols as known from the prior art. Any chemistry known to a skilled person in the art may be used to realize these strategies. Activation and derivatisation reactions are closely related to the concepts as used in peptide synthesis.

The methods, substances, and reactions as e.g. published in Houben-Weyl, Vol. E 22a, 4th Edition Supplement are applicable in many respects. Mainly the chapters carbodiimides, active esters, carbonyl diimidazole (CDI), and mixed anhydrides are useful.

Without any limitation of other suitable and accessible sources, the following citations are containing useful protocols for polymer immobilization and derivatization, also comprising the chemistry of functional group activation: WO 90/14886, WO 98/32790, WO 96/09116, EP 1 224 975, and Journal of Chromatography, 587 (1991) 271-275.

### Design

The following are preferred design features of polymeric mesh adsorbents.

In a preferred embodiment, in combination with the above and below embodiments, the polymeric mesh adsorbent or the filter medium is comprising a composite material, wherein at least two different functional polymers are immobilized to at least one support material, and whereas each particular functional polymer preferably adsorbs at least one distinct contaminant or at least a couple of chemically related contaminants from a gas.

Examples of chemically related substances are isomers, homologous compounds, but also biopolymers exhibiting defined ranges of molecular mass or isoelectric points.

Said at least two polymers are either subsequently attached or introduced to the support material thus forming two layers, or they are reacted as a mixture thus forming one layer.

The order of polymer introduction is arbitrary.

The following parameters, features and materials are varied and combined according to the present application in order to design a polymeric gel or a composite material with appropriate porosity, affinity, selectivity and capacity:

The pore size distribution of the support material.

The structure of the polymer, mainly its chemical constitution, molecular mass, configuration, and conformation.

The concentration of the particular polymer during the synthesis and the immobilized amount of each particular polymer.

The cross-linker used, mainly its length, polarity, and functional groups.

The derivatisation reagents used.

The degree of cross-linkage of the polymeric layers.

The reaction pathway of polymer immobilization, precipitation, or synthesis.

The solvent, mainly the solvent polarity, used for the dissolution of the particular polymers and cross-linkers applied for the preparation of the polymeric mesh.

The variation of the pH of said solvent used for the preparation and thus the degree of ionization of the acidic and/or basic residues of the polymer.

### DETAILED DESCRIPTION

The following are preferred embodiments relating to the application of a polymeric mesh adsorbent, respectively a filter medium or a filter element, also relating to the selection of polymers and support materials. Moreover, these embodiments are relating to immobilization or derivatisation, and also to the structure and design of a polymeric mesh.

### Application of a Polymeric Mesh Adsorbent and Methods for the Removal of Contaminants

In preferred embodiments, in combination with any of the above and below embodiments, the contaminant retaining polymer is preferably a functional polymer, more preferably a basic or acidic polymer, most preferred an amino group, acid group, or hydroxyl group containing polymer.

Therefore present invention is related to

a method for the removal of contaminants comprised in a liquid, in a gas, or mixture of gases,
using at least one composite material, comprising at least one support material, and at least one immobilized functional polymer,
wherein said at least one immobilized functional polymer is retaining at least one of said contaminants.

The present invention is also related to

a method for the removal of contaminants from a liquid or gaseous substance mixture,
using at least one composite material comprising at least one support material, and at least one immobilized polyamine,
wherein said at least one polyamine is retaining at least one of said contaminants.

The present invention is also related to

a method for the removal of contaminants from a liquid or gaseous substance mixture,
using at least one composite material comprising at least one support material and at least one immobilized polymeric acid,
wherein said at least one immobilized polymeric acid is retaining at least one of said contaminants.

In another preferred embodiment, in combination with any of the above and below embodiments, a polymeric mesh is comprising at least one support material made from the same polymer as the adsorbing polymer.

In another preferred embodiment, in combination with any of the above and below embodiments, a composite material comprises at least one support material made from the same or a different polymer as the adsorbing polymer.

The support material of the above embodiments is preferably a tissue or fabric.

In a further preferred embodiment, in combination with any of the above and below embodiments, a polymeric mesh is comprising a gel made entirely from the adsorbing polymer.

In preferred embodiments, in combination with any of the above and below embodiments, the polymeric mesh adsorbent of the present application, comprising at least one adsorbing polymer, is used for the applications of contaminant removal as listed above and below, also in combination with or as a part of the related devices and products.

Those filter applications using adsorptive media of the present application are preferably concerning the areas of:

HVAC (Heating-Ventilation-Air-Conditioning) meaning intake air filtration of e.g. residential areas, office buildings market or store areas, industrial, medical or pharmaceutical clean rooms, laboratories, public buildings, passenger ships or air crafts, passenger trains.

Intake air filtration or air conditioning units for motor driven vehicles like e.g. passenger cars, trucks, busses, agricultural or landscaping vehicles.

Industrial exhaust systems with or without return air especially in a 2^{nd} or 3^{rd} filtration step, e.g. dust removal units, smoke extraction as used for welding, plasma-.or laser cutting, removal of pharmaceutical or food powders, separation and recycling of powder paints.

In these application fields the adsorption media of the present application are preferably used after a first mechanical filtration step.

Cleaning of respiratory air like e.g. respiratory protection helmets or—masks.

The air which is fed into these areas needs to be preferably filtered from air born particles, pollen, spores, soot from combustion processes, bad smells, hazardous or corrosive gas components, and sometimes bacteria and viruses, and any related degradation products.

As there is a need for the removal of very fine particles, aerosols and other components transported in the air in numerous everyday applications, because these contaminants are often providing hazardous or allergenic effects to people, the present application is providing several materials and applications in order to enable relating solutions:

Especially for sterile or allergen free requirements filters EPA, HEPA or ULPA filters acc. DIN EN 1822 mostly made by micro glass fibre filters are state of the art, as they are able to remove any contaminant of the afore mentioned particle size.

But not only air filters acc. to DIN EN 1822 can benefit of the present embodiments. Also filter elements which are classified acc. EN 779 or ISO 16890 or cabin air filter elements tested acc DIN 71460 or ISO/TS 11155 can make use of it, in case the filter media are treated according to the present invention. Another relevant application can be breath protection filters as specified under EN 149.

With respect to the abovementioned filter types the present application is providing alternative solutions by treating any substrate or support material with an adsorption layer capable of eliminating such contaminants at least as well.

Liquid filtration applications like production or sterile water are also within the scope of the present application, comprising any structural or synthetic embodiments, also in combination with any of the above or below embodiments.

Accordingly is the present invention related to

at least one of the abovementioned filter applications for the removal of contaminants comprised in a gas,
using at least one polymeric mesh comprising at least one immobilized functional polymer,
wherein said at least one immobilized functional polymer is retaining at least one of the above listed contaminants.

### Polymers

With respect to the present application any co-polymer comprising at least one amino, carboxyl, sulphonyl, phosphonyl, thiol, or hydroxyl group, or a combination of at least two of said functional groups is deemed within the definition of functional polymers.

Preferably the functional polymer is bearing at least one OH—, SH—, COOH—, —SO₃H, —PO₄H₂, —PO₃H, epoxy, or primary or secondary amino group.

In a preferred embodiment, in combination with any of the above or below embodiments, the functional polymer is an amino group containing polymer (“a polyamine”), or an oligomer with at least three amino groups. Amino groups are primary and secondary.

In addition to the abovementioned polyamines, the composition of poly(vinylformamide-co-vinylamine) is most preferred, comprising 5% to 80% of poly(vinylformamide), preferably 10% to 40%, more preferred 10% to 20%. In a further preferred embodiment, in combination with any of the above or below embodiments, the polyamine is a mixture of a poly(vinylamine) and poly(vinylformamide-co-vinylamine).

Within a preferred embodiment, in combination with any of the below embodiments, technical grade, raw functional polymers and solutions thereof are used in order to synthesize the composite adsorbent.

Preferably raw poly(vinylamine) or poly(vinylformamide-co-vinylamine) solution is used, containing the salts, sodium hydroxide, sodium formate, and other side products from the polymer manufacturing process

As the low molecular weight impurities and side-products of said technical grade polymers in general are easily washed out after the polymer immobilisation, the final polymeric mesh adsorbent exhibits a high purity.

### Support Materials

Among particulate support materials those with an average particle size of 3 μm to 10 mm are preferred, more preferably between 20 μm and 2000 μm, most preferred between 35 μm and 500 μm.

When the particulate or monolithic support material is at least in part porous average pore sizes of 2 nm to 5 mm are applicable, preferred are pore sizes between 15 nm and 500 nm, more preferred is the range between 10 nm and 100 nm, most preferred between 15 nm and 30 nm, determined with the usual methods as applied by the manufacturers.

In a preferred embodiment, in combination with any of the above or below embodiments, the particulate or monolithic porous support materials are composed of a metal oxide, a semimetal oxide, ceramic materials, zeolites, carbon, or natural or synthetic polymeric materials.

In a further preferred embodiment, in combination with any of the above or below embodiments, the fibrous, particulate or monolithic support material is porous cellulose, a derivative of cellulose, chitosane or agarose.

Most preferred are cellulose, methyl cellulose, and acetyl cellulose, either fibres, particles or monoliths. Porous materials as used for the production of cigarette filters and sponges are also preferred.

In a further preferred embodiment, in combination with any of the above or below embodiments, the fibrous, particulate or monolithic support material is comprising porous or non-porous poly(acrylate), poly(methacrylate), poly(etherketone), poly alkylether, poly arylether, poly (vinylalcohol), poly(vinylacetate), poly(vinylpyrrolidon), or polystyrene.

In a further preferred embodiment, in combination with any of the above or below embodiments, the particulate or monolithic support material is silica, alumina, zirconia or titanium dioxide, preferably with an average pore size (diameter) between 20 nm and 100 nm (as analyzed by mercury intrusion according to DIN 66133) and more preferably a surface area of at least 100 m²/g (BET—surface area according to DIN 66132).

Even more preferred are silica gel materials, exhibiting an average pore diameter of 20-100 nm.

Most preferred is irregular silica with a BET surface area of at least 150 m²/g, preferably 250 m²/g and a pore volume (mercury intrusion) of at least 1.5 ml/g, preferably 1.8 ml/g.

### Immobilization

The following embodiments, in combination with the above and below embodiments, are describing immobilisation conditions in general.

The amount of polymer introduced into the support material and immobilized is preferably controlled by the polymer concentration in the respective reaction solution.

Concerning particulate or monolithic support materials, the degree of support pore filling and the mesh size distribution under application conditions is achieved and determined by introduction and immobilization of different polymer amounts and by the subsequent measurement of the pore size distribution using iSEC.

The degree of polymer immobilization is exactly determined and standardized by weighing the wet and dry materials before and after introduction of the polymer and cross-linker solutions.

The amount of polymer to be immobilized is preferably adjusted by the polymer concentration in the reaction solution. Hence, the maximal possible polymer amount, which can be immobilized, is easily elucidated.

The functional polymer is immobilized preferably by cross-linking when the reagent is at least bi-valent. Cross-linking is preferably achieved via covalent, ionic or dipolar bonds, like hydrogen bridges, or a combination of at least two of said interactions.

Immobilisation moreover comprises the co-valent or non-co-valent attachment of a functional polymer to a previously provided layer, either being also a polymer, or a reagent, or a support material. The resultant mesh is preferably not soluble in the solvents of preparation and application. The reagent is preferably capable of derivatisation or cross-linking.

In combination with any of the above or below embodiments, the cross-linker is preferably a bis-oxirane or a bis-aldehyde such as succinic or glutaric dialdehyde, as long as the polymer is harboring amino groups. Bis-oxiranes are also applicable together with polymeric alcohols and thiols. Preferred oxiranes ethyleneglycol-, propyleneglycol-, butanediol-, or hexanedioldiglycidylether, more preferred is poly (ethyleneglycol diglycidylether) with a molecular mass between 500 Da and 10.000 Da. If a bis-aldehyde is used as the cross linker, a subsequent reduction step is advantageous for stabilisation purposes.

Crosslinkers with more than two reactive groups are also applicable, e.g. ipox CL 60 (Ipox Chemicals GmbH).

Amino polymers are preferably cross-linked or derivatized in aqueous solution, whereas the pH is between 8 and 13, preferably between 9 and 12, most preferred between 10 and 11.

In one preferred embodiment, in combination with the above and below embodiments, after contacting the polymer solution with a support material, the polymers are preferably cross-linked either after aspiration of the initial solution, after partial evaporation, e.g., a concentration step, or after the complete evaporation of the solvent.

The cross-linker is preferably added to the polymer solution already before contacting the support material, when the cross-linking process shall take place in the initial or concentrated solution.

Provided that this reaction is performed after evaporation, the dissolved cross-linker is added in a separate step.

Within another preferred embodiment, in combination with the above and below embodiments, the cross-linker solution is attached to the support surface or introduced into the pores before the particular polymer solution is applied. The cross-linker solvent is evaporated in part or completely before the particular polymer solution is applied.

Within a further preferred embodiment, in combination with the above and below embodiments, at least a portion of the polymer is adsorbed after contacting the surface containing the cross-linker, and the cross-linker is diffusing into the polymeric layer, reacting with the functional groups of the polymer. The solvent of the polymer may be concentrated, aspirated or even evaporated in order to optimize the polymer deposition.

Within another preferred embodiment, in combination with the above and below embodiments, the particular polymer solution is attached to the support surface or introduced into the pores before the cross-linker solution is applied. The polymer solvent is evaporated in part or completely before the particular cross-linker solution is applied.

In a further preferred embodiment, in combination with any of the above and below embodiments, polymer layers and cross-linker layers are attached subsequently without the application of a support material, whereas the preferably dry first layer, either polymer or cross-linker, serves as the basis for such a multi-layered material, preferably capable of forming a gel in the swollen state.

Provided that the first layer will be only provisionally attached to a basis material like a glass sheet, this basis may be removed after finishing the synthesis, and thus will not become part of a composite material. Also in this case the resultant product is a gel.

It is also possible to bind the first layer by means of co-valent or non-covalent interaction to said basis material, thus forming a composite comprising a basis support and a multi-layered polymeric mesh.

The cross-linking or derivatisation is preferably achieved by introduction of thermal, oscillation, vibrational, or radiation energy, using e.g. an oven, a microwave oven, an ultrasonic bath, and any irradiation techniques as known from the prior art. The energy input may be performed under reduced pressure or in vacuo.

Within these embodiments, in combination with the above and below embodiments, a cross-linker is preferred which does not significantly react within a time period below 30 min. under the conditions of mild solvent aspiration or evaporation, preferably below 40° C., more preferred below 50° C. Preferred cross-linkers are bis-epoxides as listed above.

Any solvent may be used for the synthesis, which does either not react or only slowly reacts with the cross-linker and/or the cross-linkable polymer under the conditions of preparation, and which preferably dissolves said reactants to at least 1% (w/v) solution.

Slowly in this context means that at the selected temperature no visible gelling occurs before at least 30 minutes, using only the polymer cross-linker solution as demonstrated within Reference Example 1.

It is advantageous for the synthesis process and the subsequent wash and equilibration to use only aqueous media, applying preferably cross-linkers soluble in water or miscible with the aqueous reaction solution.

In a preferred embodiment, in combination with any of the below embodiments, the cross-linking reaction is not started already during the contact with the support surface or pore filling, but subsequently, preferably at elevated temperature or with a pH shift. The cross-linking with epoxide cross-linkers or epoxy-activated polymers is thus started at temperatures above 50° C., preferably between 60° C. and 180° C., more preferably between 80° C. and 120° C., while at room temperature no visible gelation occurred after 30 minutes, preferably not after two hours.

In a preferred embodiment, in combination with any of the below embodiments, the object of the present invention is reached by the reaction of at least one shrunken cross-linkable polymer, preferably functional polymer with at least one cross-linker, thus forming at least one polymeric mesh, which is selectively swollen or shrunk in certain solvents or buffers.

This is the preferred way how to attach the first polymeric layer.

In a preferred embodiment, in combination with any of the below embodiments, the polymeric mesh adsorbent is comprising at least one functional polymer.

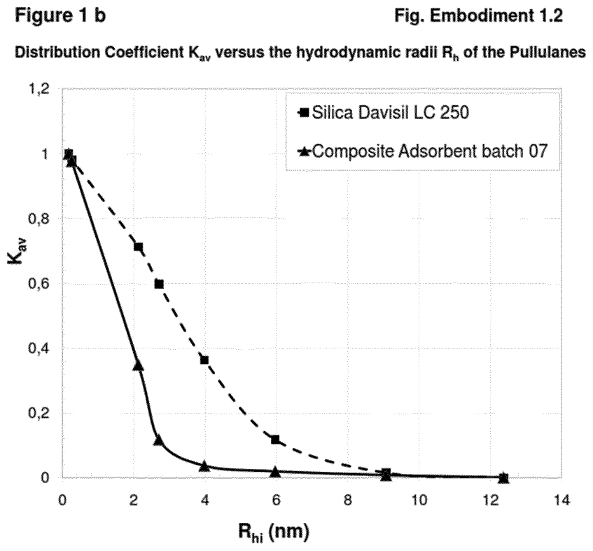

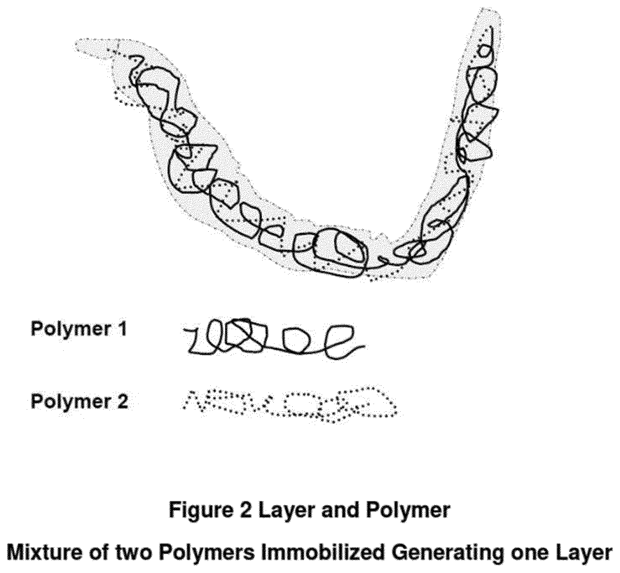

In a further preferred embodiment, in combination with any of the below embodiments, the at least one functional polymer is attached within at least one layer. Layer means the polymer fraction attached in a single step (see FIGS. 2 and 3). When at least two functional polymers are immobilized subsequently within at least two layers, they may comprise either the same or a different structure. Structure means the constitution, configuration, conformation, also as defined by the molecular weight distribution. The shrunken and the swollen conformation of the same polymer are thus defined as different structures.

Alternatively, in a different embodiment, in combination with any of the above or below embodiments, the first polymer may be covalently attached to the surface of the support material, and optionally cross-linked in addition.

In further preferred embodiments, in combination with the above and below embodiments, at least two polymers comprising either amino, carboxyl, or ester groups, or hydroxy or thiol groups, or a combination thereof within at least one polymer, is contacted with a surface as a mixture and immobilized at an appropriate temperature, thus forming one layer.

In further preferred embodiments, in combination with the above and below embodiments, at least two solutions, any of them comprising at least one polymer or polymeric structure are subsequently applied, whereas the solvent is, at least in part, evaporated after each step of exposure, whereas the respective polymer is immobilized.

As it is difficult to steer and determine the degree of cross-linking and derivatisation using the above and below ways of synthesis, a standardisation method was introduced applying thermogravimetry as an analytical method. Preferably with acidic polymers and amino polymers the loss of weight over temperature allows to determine the degree of cross-linking and the degree of derivatisation, when applied together with the acid-base titration of the ionisable functional groups.

In addition, thermogravimetric comparisons of the polymeric mesh as neutralized salt vs. the free acid or base deliver the degree of derivatisation or cross linking, too. Accordingly the hydrochlorides of a poly(vinylamine) starting material and of the cross-linked poly(vinylamine) were compared with its free base. In order to measure extractables, the loss of weight was determined using thermogravimetry after repetitive intensive washing procedures of a composite material or polymeric gel with suitable solvents, e.g. basic and acidic solvents in the case of charged polymers like polyamines or polyacrylates.

For all these reasons a precise dosage of reagent is required when a defined degree of derivatisation or cross-linking is the object.

Active or activated groups of at least bivalent reagents remaining after the cross-linking, without reaching a partner for a reaction, are finally quenched using appropriate common methods. Oxirane rings are opened under acidic conditions, preferably with 0.5 M to 2 M hydrochloric acid.

The only difference, basically generating either derivatisation or cross-linking is the number of functional groups of the reagent. Mono-valent reagents are capable of derivatisation only. Bi-valent or higher valent reagents are used for cross-linking preferably, most preferred when present in stoichiometric ratios below 50%. Any excess of multi-valent reagent concentration, even only locally available, may result in derivatisation, eventually together with cross-linking. The major reason is a stereochemical impact, because not always both ends of the cross-linker will come in contact with a functional group of the polymer.

### Function, Structure, and Design

In preferred embodiments, in combination with any of the above and below embodiments, the polymeric mesh is made from at least one functional polymer without support materials, and the resultant gel is either comprising porous or non-porous particles or a porous or non-porous monolithic product, or a fibrous product. In one further embodiment, in combination with any of the above and below embodiments, said gel comprising at least one functional polymer is retaining at least one contaminant from a liquid or a gas.

Examples of such functional polymers as starting materials for gel synthesis are preferably cellulose, acetylcellulose, methylcellulose, chitosan, poly(methacrylate), poly(vinylalcohol), and poly(vinylamine), and co-polymers thereof.

The relating particles or fibres or threads may be totally porous, or comprise a solid core covered with a porous coat.

In another preferred embodiment, in combination with any of the above and below embodiments, the at least one functional polymer serves also as the support material thus forming a composite. Accordingly, it is possible to prepare a base layer comprising a porous or preferably non-porous polymer, e.g. polyamine, subsequently attaching porous layers of the same polyamine on the surface of the base layer.

Fibrous products of the present application may be woven or non-woven tissues or fabrics, comprising at least one particular thread covered or coated with at least one polymeric mesh.

Fibrous products are comprising at least one sort of fibre, wherein each of them may comprise at least one distinct polymeric mesh.

In preferred embodiments, in combination with any of the above and below embodiments also a combination or mixture of at least two different adsorbents is applicable, comprising at least one polymeric mesh of the present application, whereas said at least one polymeric mesh is equipped with at least one adsorptive functional polymer. At least one of the at least two different adsorbents is comprising a filter element, either made from particles, tissue, monoliths, or membranes, preferably a microfilter or an ultrafilter.

### Polymer Constitution.

In order to bind any substance which can enter a pore volume of at least one polymeric mesh, preferably of a composite material, the adsorptive polymeric layers are preferably exhibiting different structures, whereas either appropriate functional groups or ligands are attached to a polymer via derivatisation, or the respective monomer units are already incorporated in a polymer, thus generating the following polarities:

a) At least one polymer is comprising cationic groups and accordingly exhibiting anion exchange properties, e.g. a polyamine.
b) At least one polymer is comprising anionic groups and accordingly exhibiting cation exchange properties, e.g. a polyacrylate.
c) At least one polymer is comprising lipophilic groups and accordingly binding nonpolar molecule sites, e.g. an N-alkyl or an N-aryl substituted polyamine.
d) At least one polymer is comprising hydrophilic groups, e.g. poly(vinylalcohol).

Preferred polymers comprising cationic groups are comprising polyamines as listed above.

Preferred polymers comprising anionic groups are comprising acidic polymers as listed above.

In one preferred embodiment, in combination with the above and below embodiments, at least one polymer exhibiting at least one ligand with one of the structural elements a), b), c), or d) is attached to at least one support material.

At least two of said polymers are either subsequently immobilized or as a mixture. In one preferred embodiment, in combination with the above and below embodiments, the attachment of at least two polymers, each of them comprising one of the structural elements a), b), c), or d), is carried out within at least two succeeding steps, each of them arbitrarily either comprising the immobilisation of one polymer or a mixture of at least two polymers. Moieties according to the structure of a) and c) may be immobilized subsequently, for example, followed by a mixture of b) and d).

Any embodiments comprising the attachment of combinations of polymers, wherein at least one polymer is comprising at least two different functional elements selected from a), b), c), and d), and whereas the polymers are immobilized subsequently or simultaneously, or alternating subsequently and simultaneously, and the related steps and orders of immobilisation are within the scope of the present invention, hence not limited to the exemplary embodiments listed below.

In one preferred embodiment, in combination with the above and below embodiments, a composite material is comprising a combination of at least two polymers, each of them exhibiting at least one ligand selected from the structures under a), b), c), or d) above. These ligands are either different or identical.

The term different is also comprising at least two ligands, exhibiting the same general character according to at least one of the categories a), b), c), or d), but a different constitution or configuration. Examples are combinations of aliphatic and aromatic ligands under c), or a succinic acid and a phthalic acid residue under b).

The relating polymers are either attached subsequently or as a mixture to one support material.

In one preferred embodiment, in combination with the above and below embodiments, a derivatisation of at least one polymer with residues comprising at least one structure according to a), b), c), or d) is carried out in advance of the polymer immobilisation.

In another preferred embodiment, in combination with the above and below embodiments, a derivatisation of at least one polymer with residues comprising a structure according to a), b), c), or d) is carried out in a solid phase synthesis after the polymer immobilisation.

In one preferred embodiment, in combination with any of the above and below embodiments, the polymeric mesh adsorbent is a composite material comprising a porous particulate support material and an immobilized, preferably cross-linked functional polymer, preferably a polyamine, more preferred a poly(ethyleneimine), poly(allylamine), poly(lysine), or poly(vinylamine), and co-polymers thereof.

The pores are usually filled with the functional polymer network or at least coated.

In one preferred embodiment, in combination with any of the above and below embodiments, the particulate mesh adsorbent is located, filled or embedded on the top of a carrier layer or filter element, or between at least two carriers or filter elements, or layers like in a sandwich.

In a preferred embodiment, in combination with any of the above or below embodiments, only the external surface of a porous support material is covered with a functional polymer. This design is advantageous for support materials displaying themselves a high affinity towards the contaminants to be removed, and in addition, exhibiting hydrodynamic radii (Rₕ) allowing the access of the relevant contaminants.

A prerequisite of this approach is the exclusion of the polymer from the support pores, preferably to a degree of 70%, more preferred 80%, most preferred 90%. Preferred for this purpose are inorganic and organic particulate or monolithic porous support materials, more preferred are silica gel, alumina, titanium and zirconium oxides, or cellulose, dextrane gels, polyacrylic and polyester materials, all of them harbouring pores within the abovementioned range of pore size.

A more preferred embodiment, in combination with any of the above or below Embodiments, is comprising silica gel covered with a polyamine, preferably poly(vinylamine), which is optionally, at least in part, formylated or acetylated.

Other preferred embodiments, in combination with any of the above or below embodiments are comprising ion exchangers or mixed-mode media as a support material, wherein the external surface is covered with a functional polymer. Also commercially available support materials are suitable for this purpose, for example a diversity of Amberchrom and Dowex resins (Dow Chemicals).

In one preferred embodiment, in combination with any above and below embodiments, a functional polymer, preferably a polyamine, exhibiting a molecular mass of at least 100.000 Da/a Rₕ value of at least 6 nm in the solvent used for the synthesis, is attached to the external surface of a support material.

The support used for the embodiments with materials, which are only coated on the exterior surface, is preferably comprising a porous material with a nominal pore diameter of 4 nm to 100 nm, preferably of 10-50 nm, more preferred of 15-30 nm.

In another preferred embodiment, in combination with any of the above and below embodiments, the mesh adsorbent is a composite material comprising a tissue, membrane, or fabric material as a support, and an immobilized, preferably cross-linked functional polymer, preferably a polyamine as listed above.

In one preferred embodiment, in combination with any of the above and below embodiments, the polyamine is cross-linked with at least one at least bivalent aldehyde or epoxy compound, as listed above.

In a further preferred embodiment, in combination with any of the above and below embodiments, and as outlined in more detail below, the polyamine is cross-linked with an at least bivalent acid.

Multi-valent acids are preferably citric acid, tartraric acid, succinic acid, glutaric acid, terephthalic acid, phosphoric acid, and sulphuric acid.

In preferred embodiments, in combination with any of the above and below embodiments, the functional polymer of said polymeric mesh, preferably of said composite materials is comprising a polymeric acid as listed above.

In one preferred embodiment, in combination with any of the above and below embodiments, a polymeric acid is cross-linked with an at least bi-valent amine or alcohol.

Polymers bearing at least one amino, carboxyl-, phosphoryl, sulphonyl-, hydroxy or thiol function are within the scope of the functional polymer definition of the present application.

Polymers bearing at least one active or activated acid function, preferably chloride, azide or anhydride function, or an activated amine, are also within the scope of the functional polymer definition. Most preferred are anhydride functions.

### The Following Embodiments are Subject to the Derivatisation of a Polymer.

In one preferred embodiment, also in combination with any of the above and below embodiments, a polymer or co-polymer is comprising anhydride monomer units, preferably maleic anhydride units. Said polymer is preferably poly(ethylene-alt-maleic anhydride) or poly(isobutylene-alt-maleic anhydride).

After reaction with a nucleophilic compound a bivalent product is generated, comprising anionic ligands and hydroxyl (groups) when reacted with water, respectively carboxyl groups together with lipophilic or hydrophilic ester or amide groups, when the reagent is, e.g., an aryl or alkyl alcohol, or an amine, preferably dissolved and reacted in an aprotic solvent.

Accordingly is the present application related to a polymeric mesh, preferably to a composite material, wherein at least one adsorptive polymer is comprising at least one poly(maleic anhydride) building block/monomer unit, which are comprising in turn precursor ligands for anionic and lipophilic or hydrophilic residues.

The present application is also related to a polymeric mesh, preferably to a composite material, wherein the at least one adsorptive polymer is comprising hydrolysed poly(maleic anhydride) monomer units, comprising anionic and lipophilic or anionic and hydrophilic residues.

In preferred embodiments, in combination with the above and below embodiments, poly(maleic anhydride) is one component of a multilayer polymeric mesh, comprising at least two layers, wherein poly(maleic anhydride) provides the first layer and at least one different functional polymer provides the second layer preferably comprising nucleophilic residues in order to react with the anhydride.

In a preferred embodiment, in combination with the above and below embodiments, a polymeric mesh containing a polyamine as a first layer is reacted with the maleic anhydride polymer at temperatures preferably between 20° C. and 120° C. over a time period between 30 minutes and 24 hours. The two polymers are connected via amide bonds and salt bridges, thus forming two layers, whereas anhydride groups remain intact for potentially desired further chemical modifications, i.e., ring opening reactions, esterification, amidation and other known typical carbonyl chemistry.

In one preferred embodiment, in combination with the above and below embodiments, the first layer is comprising a polymer or copolymer containing maleic anhydride units, preferably poly(isobutylene-alt-maleic anhydride) or poly(ethylene-alt-maleic anhydride), and after evaporation of the solvent, a polyamine is introduced, preferably dissolved in water and optionally together with a cross-linker, the resultant intermediate composite is preferably aspirated, and the compounds are reacted at temperatures preferably between 20° C. and 120° C. for 30 minutes to 24 hours. The residual anhydride residues are finally converted into carboxyl groups together with hydroxyl, ester or preferably amide residues, preferably by reaction with modestly nucleophilic compounds like polyols, or primary or secondary alcohols, more preferred with amines.

In one preferred embodiment, in combination with the above and below embodiments, the amino polymer and the nucleophilic compound are added simultaneously.

In one embodiment, in combination with the above and below embodiments, the maleic anhydride polymer is cross-linked prior to the addition of the aqueous polyamine solution, preferably using a defined amount of bi- or multivalent nucleophilic reagent, preferably a diol or a diamine, more preferably an aliphatic or aromatic diamine. Most preferred are ethylenediamine, propylene diamine and 1,4 bis (amininomethyl)benzene.

Lipophilic in the context of the present application means that the respective polymer is bearing either aliphatic or aromatic, heterocyclic and/or other hydrocarbon groups at a degree of derivatisation between 2% and 98%, preferably 5% and 80%, most preferred 10% and 50%.

In preferred embodiments, in combination with the above and below embodiments, lipophilic ligands or residues are benzoyl-, benzyl-, phenyl-, naphthyl-, short- and long chain alkyl- (n=1 to 20), different kinds of branched alkyl, cyclopentyl-, or cyclohexyl-.

In one preferred embodiment, in combination with the above and below embodiments, a lipophilic derivatisation reagent is comprising at least one active group, preferably epoxy, acid anhydride, acid chloride, or azide, preferably capable of reaction with polyamines, polyalcohols, or polythiols. Also active triazine compounds are applicable for derivatisation, e.g. various monochloro triazines.

When the lipophilic residues are already incorporated to a precast polymer or copolymer, the concentration of lipophilic groups should be within the same range as described above and below for the derivatisation of immobilized polymer layers.

In the dry state or preferably at an air humidity between 10% and 90% an interior and external lipophilic surface will exhibit an enhanced affinity for almost any substances transported in a gas stream, preferably for proteins, peptides, lipoproteins, lipo(poly saccharides) and related compounds, which are small enough to enter the pore of the polymeric mesh. The adsorption is facilitated when the contaminants are initially embedded in drops or an aerosol.

In one preferred embodiment, in combination with the above and below embodiments, the polymeric mesh is binding aerosols and drops, preferably comprising water or aqueous compositions as a solvent, more preferably adsorbing contaminants dissolved or suspended in aerosols.

Within a preferred embodiment, in combination with the above and below embodiments, the polymeric meshes are therefore comprising lipophilic ligands in a concentration between 2% and 98%, preferably 5% and 80%, most preferred 10% and 50%, related to the concentration of initially or totally available functional groups.

It must be avoided, however, to glue lipophilic polymer chains together. As a consequence, the accessible surface area may drop, thus decreasing also the targeted binding capacity. For this reason the concentration of the lipophilic ligands must not exceed a critical score, which has to be figured out experimentally, e.g. using inverse size exclusion chromatography, or more simply testing the binding capacity of polymeric meshes with different degree of lipophilic derivatisation using a model protein with a molecular size of typical contamination compounds. The binding capacity of amino containing polymers incorporated to a mesh is preferably tested with a solution of albumin, immobilized acidic polymers are tested with e.g. lysozyme, both preferably at a concentration between 20 mM and 1 M. After equilibration the residual protein concentration in the supernatant may be determined using a UV test at 254 nm.

In one preferred embodiment, in combination with the above and below embodiments, also a combination or mixture of at least two adsorbents is applicable for the removal of contaminants from a gas, preferably comprising at least one polymeric mesh of the present application, whereas each polymeric mesh is equipped with at least one adsorptive polymer.

Design of Materials with High Partitioning Coefficients, Preferably Polymers Derivatized with at Least Two Ligands.

A further subject of the present invention is the design of materials with high capacity and partitioning coefficients towards the various contaminants in a liquid or gas.

This goal is preferably reached by the immobilisation of at least one functional polymer, thus resulting in a polymeric mesh, more preferred by attachment of at least one functional polymer on a support material, generating a composite with a porous polymeric coating.

In one preferred embodiment, in combination with any of the above or below embodiments, at least one polymer is immobilized within at least one layer on at least a part of the support surface (FIGS. 2 and 3) in at least one step of preparation, thus forming a composite comprising at least one discrete layer of surface coating.

A layer is defined as the portion of at least one polymer which was immobilized in one step of preparation. The boundary surface between the previously attached layer and the layer attached with the subsequent step is the site where these two layers are contacting each other. They may also slightly permeate each other.

The terms adsorption and non-covalent interaction are used as synonyms throughout the present application.

Affinity is a synonym for the potential binding of a particular substance or group of chemically related substances by an adsorbent, and is correlated with the partitioning of each particular substance between the two phases solid and gas, as expressed by the partitioning coefficient P.

The partitioning coefficient P is defined as

P=c_{solid}/c_{gas}

c_{solid} is the equilibrium concentration of said compound in the solid phase.

c_{gas} is the equilibrium concentration of said compound in the gas phase.

A corresponding equation is applicable for a partitioning between a solid phase and a liquid.

Retained by the adsorbent means the depletion on the surface or inside of the polymer pores, due to any non-covalent or covalent binding mechanism like adsorption, or due to a partitioning, size exclusion, or extraction mechanism.

Most preferred in order to design affinity is the allocation of at least one functional polymer comprising a variety of structural elements, complementary to the binding sites of the contaminants/undesired compounds.

The affinity is already increased by a simultaneous non-covalent, “multi-valent” interaction of at least two residues of the at least one functional polymer with at least two residues of the target contaminant. The resulting Gibbs energy of an at least bi-valent binding event is accordingly exceeding the Gibbs energy of a monovalent interaction. Said at least two residues of the polymer may be different or equal. Also the at least two residues of the contaminant may be different or equal.

In preferred embodiments, in combination with any of the above and below embodiments, at least two equal functional groups or residues, preferably at least two different functional groups or residues of the at least one functional polymer are complementary with at least two equal functional groups or residues, preferably the at least two different functional groups or residues of a contaminant.

In further preferred embodiments, in combination with any of the above and below embodiments, at least two equal functional groups or residues, preferably different functional groups or residues of at least two functional polymers are complementary with at least two equal functional groups or residues, preferably different functional groups or residues of the contaminant.

The derivatized or underivatized functional groups may be located on different functional polymers or on the same functional polymer, respectively on particular chains, coils or globules thereof. They may also be distributed to at least two functional polymers and to particular chains, coils and globules thereof.

When at least two different polymer derivatives are used, the derivatisation residue may be located to different functional polymers or to the same functional polymer. In one preferred embodiment, in combination with the above and below embodiments, two batches of poly(vinylamine) are separately derivatized with e.g. phenyl and alkyl groups, and the derivatives are subsequently mixed and optionally immobilized. Alternatively two different polymers may be derivatized with the same or at least two different ligands, e.g. poly(vinylamine) with formyl groups and poly(vinylalcohol) with a glycidylether.

In a further preferred embodiment, in combination with the above and below embodiments, the polymer may be derivatized with two different ligands, either attached simultaneously or subsequently.

Complementary means in the context of the present application, that a particular functional group or residue of the adsorbent and a that a particular functional group or residue of a contaminant exhibit enough energy of non-covalent interaction (Gibbs energy) after contacting in the medium of application, in order to bind both moieties together.

In one preferred embodiment, in combination with any of the above and below embodiments, said variety of structural elements, complementary to the binding sites of the contaminants/undesired compounds, is accomplished by derivatisation of the at least one functional polymer itself, of the at least one polymeric mesh, e.g. by derivatisation of the porous coating of composites.

The derivatisation of functional polymers is achieved either in advance of the immobilisation or subsequently.

Preferred ligands are basic, acidic, hydrophilic or lipophilic as listed within the above and below embodiments.

Preferably the ligands for a resultant polymeric mesh are selected complementary to prominent groups or epitopes of a target contamination.

In one further preferred embodiment, in combination with any of the above and below embodiments, the at least one amino group of the immobilized amino polymer is derivatized with at least one reagent, and thus used for the removal of contaminants.

In another preferred embodiment, in combination with any of the above and below embodiments, the at least one acidic group of the immobilized polymeric acid is derivatized with at least one reagent, and thus used for the removal of contaminants.

In another preferred embodiment, in combination with any of the above and below embodiments, the at least one hydroxy or thiol group of the immobilized polymeric alcohol respectively thiol, is derivatized with at least one reagent, and thus used for the removal of contaminants.

Any method or protocol for derivatisation as known from the prior art may be applicable for the synthesis of the above and below embodiments.

### Synthesis of Materials for the Removal of Contaminants and for Separation Processes Using Compounds Neither Activated Nor Active,

In comparison with the prior art and according to the aforesaid reasons, when conducting any polymer immobilisation, cross-linking, or derivatisation based on amide or ester bonds, a more simple and cheap synthesis would be required for the production of bulk commodities. Avoidance of organic solvents and of active or activated reagents is important for this purpose. Thus, reaction pathways in aqueous systems or even in a dry state or in a melt would be preferred.

Accordingly it is one object of the present invention to provide methods for the synthesis of a polymeric mesh adsorbent, preferably of a composite, comprising amide or ester bonds, wherein the starting materials are neither active nor activated. In addition, the reaction should be possible in aqueous solvents, preferably in water, or after drying the ingredients in the solid or molten state.

The reaction should be preferably achieved at enhanced temperature and completed within a few minutes.

The above objects are accomplished according to the present invention using building blocks for the synthesis preferably comprising the following functional groups, capable of ester, thioester, or amide formation: primary or secondary amino groups, hydroxyl, carboxyl, ester, carbonyl, thiol, sulphonic acid, and phosphonic acid residues.

The present invention is therefore providing a principle and a general method of polymer immobilisation and derivatisation, reacting a polymer comprising at least one of said functional groups (a functional polymer) with at least one compound comprising at least one functional group capable of reacting with the at least one functional group of the polymer, thus forming either an amide, an ester, or a thioester bond. Said at least one other compound is comprising a derivatisation reagent, a cross-linker or a second polymer.

Preferably ionizable compounds, like polyamines together with at least one acidic or ester reagent, can be applied for derivatisation and cross-linking.

Any direct reaction of nucleophilic compounds like amines or hydroxyl with electrophilic compounds like carboxylate is slow at ambient temperature or will even not progress at all. This kind of conversion will require a significant energy input, preferably at enhanced temperature.

Amides and esters may be formed by heating the components, whereas water is cleaved and favourably evaporated.

### Amide Formation

Amides are preferred for the purpose of the present application due to their chemical and mechanical stability, but also because of their capabilities as an adsorbent. Thermal amidation and esterification procedures should be basically applicable for polymer-analogous reactions in solution (see e.g. Beckwith, in Zabicky, The Chemistry of Amides, pp. 105-109, Interscience Publishers, New York, 1970).

There was a huge difficulty, however, treating functional polymers with cross-linkers, both bearing ionizable functional groups: When mixing aqueous solutions of e.g. a polyamine with a multi-valent carboxylic acid or of a polyacrylate with a diamine, it was found that precipitates are immediately formed. This undesired result is probably caused by a rapid ionic or polar cross-linking of the polymer coils or globules in solution or suspension. As a consequence, these viscous suspensions were not capable of entering the micro-pores of a support material any more. In addition, it was not possible to homogeneously distribute this paste on the surface of a thread or string forming a tissue.

Accordingly, the generation of defined porosities and the coating of surfaces via thermal amide formation seemed to be hardly feasible in this way.

The above impediments are overcome and the objects are accomplished according to the present invention by means of the measures as described below.

It has been found that the reaction takes place at a high yield in the desired way, when the reactants are introduced into the pores of a support material or applied to a surface not together as a mixture, but subsequently, and the reaction is started when all compounds are in place. As the reactants are initially located in form of discrete layers, an entire cross-linking reaction was unexpected. A thorough mixing of the dissolved or molten reaction compounds would be requisite in order to achieve a homogeneous and stabile product.

In preferred embodiments, in combination with any of the above or below embodiments, said reaction of subsequently introduced building-blocks is not limited to amidation, esters and thioesters are obtained in the same way.

Starting from either polymeric esters or from esters as a cross-linker, alternatively, no spontaneous cross-linking occurs in solution or suspension. Thus both reactants, ester and amine, can be applied together to a surface forming one layer.

Accordingly amides are formed mixing polyamines and esters, or polyesters and amines (see e.g. Jerry March, Advanced Organic Chemistry, McGRAW-HILL, ISBN 0-07-085540-4, O-57).

Esters are also obtained via transesterification, starting from polyalcohols and esters, respectively polyesters and alcohols.

In these cases the reaction compounds are preferably soluble in the same solvent, because it possible to apply them together to the support material without undesired preliminary reaction. The solvent is more preferably aqueous, most preferred are water or buffers.

The method of stepwise introduction of the reactants is more versatile and comprehensive, however.

### Stepwise Immobilisation of Functional Polymers and Stepwise Derivatisation, Always Using Compounds Neither Activated Nor Active,

In one preferred embodiment, in combination with the above and below embodiments, a polymeric mesh, preferably a composite material is prepared, wherein a solution comprising at least one functional polymer is introduced first to the surface of a support material, and the solvent is evaporated to a certain degree or completely. Then, within a second step the cross-linker solution is applied, comprising at least one bi-valent reagent, a compound comprising at least two functional groups, complementary with the functional groups of the polymer and the materials are immobilized, preferably by cross-linking, preferably at enhanced temperature.

In another preferred embodiment, in combination with the above and below embodiments, the cross-linker solution comprising at least one bi-valent complementary reagent is introduced first to the surface of a support material, the solvent is evaporated to a certain degree or completely. Then a solution comprising at least one functional polymer is applied within a second step, and the materials are immobilized, preferably by cross-linking, preferably at enhanced temperature.

In an additional preferred embodiment, in combination with the above and below embodiments, a polymer already immobilized to a surface is comprising complementary functional groups. Then a solution comprising at least one functional polymer is applied immobilized, preferably at enhanced temperature.

One example is comprising a polyamine reacted with a polyvinylacetate, or a polyacrylic ester.

In a further preferred embodiment, in combination with the above and below embodiments, the surface of a support material itself is comprising functional groups, and a solution comprising at least one functional polymer is applied and immobilized, preferably by cross-linking, preferably at enhanced temperature.

One example is comprising aminopropyl silica reacted with polyvinylacetate or a polyacrylic ester.

Within the above embodiments partially hydrolysed polyvinylacetate or a polyacrylic ester, or copolymers comprising free hydroxyl, respectively carboxylic groups are preferred.

The solvent of the last compound introduced, preferably water or aqueous mixtures, may be removed in part or completely before the reaction is started. Usually the evaporation proceeds in parallel with the reaction, as soon as the necessary temperature is reached.

After contacting, a sufficient mixing of both compounds is preferably achieved in the solvents of application at enhanced temperature, allowing the small cross-linker molecules to diffuse into the polymer layer. Provided that the melting point of the polymer-reagent-mixture is low enough to avoid degradation, the reaction is alternatively carried out in the molten state.

Using ionic or ionisable reaction partners, the immobilization may be due to the formation of covalent bonds, ionic bonds or a combination of both.

Using one ionic or ionisable reaction partner together with a compound comprising neutral polar functional groups like OH—, the immobilization may be due to the formation of covalent bonds, polar non-covalent interactions, or a combination of both.

With respect to the above and below embodiments of immobilisation and derivatisation of compounds, neither activated nor bearing active groups, functional polymers are comprising at least one primary or secondary amino group, one carboxy, ester, carbonyl, sulphonate, phosphonate, hydroxyl, or thiol group, or a combination of at least two of the above functional groups. Preferred polymers are poly(alcohols), poly acids, poly(esters), and polyamines, more preferred are the building blocks listed in the above chapters about polymers.

The reactants are contacted with the support material preferably together in one solution, when either the polymer or the reagent is an ester. Esters are reacted either with alcohols, amines or with ammonium cations. When both reactants are ionisable or ionic, the respective solutions are subsequently contacted with the support material.

Preferred cross-linkers for poly acids are at least bi-valent amines, alcohols, thiols, or amino alcohols. Multi-valent amines are primary or secondary. Preferred derivatisation reagents for poly acids are mono-valent amines, alcohols, and thiols. Preferred mono-valent amines are primary, secondary, or tertiary, inclusive the related chiral building blocks. More preferred are phenyl ethylamines, naphthylamines, benzylamine, any C-terminal protected amino acids like e.g. phenylalanine benzylester.

Preferred cross-linkers for polymeric esters are at least bi-valent amines, alcohols, thiols, or amino alcohols. Preferred polymeric esters are poly(vinylacetate) and esters of poly(acrylic acid) or polymeth(acrylic acid).

Preferred derivatisation reagents for polymeric esters are mono-valent amines, alcohols, thiols, or amino alcohols.

Preferred cross-linkers for polyamines or polyalcohols are multi-valent esters and acids, preferably organic acids like aliphatic, aromatic, or araliphatic carboxylic, sulfonic and phosphonic acid, but also inorganic acids like phosphorous and sulphuric acid.

More preferred are citric, malic, tartraric, oxalic, succinic or glutamic acid.

Preferred esters are dimethyloxalate, or dimethylsuccinate.

Also preferred cross-linkers for polyamines are multivalent aldehydes and ketones.

Preferred derivatisation reagents for polyamines or polyalcohols are mono-valent esters and acids, preferably organic acids like aliphatic, aromatic, or araliphatic carboxylic acids, inclusive the related chiral building blocks.

More preferred are phenyl acetic acid, phenyl propionic acid, and any N-terminal protected amino acids.

Preferred esters are methyl and ethyl esters of carboxylic acids, also of hydroxy acids, more preferred made from phenylacetic acid, phenylpropionic acid, mandelic acid, lactic acid, glycolic acids, glyceric acid, glucuronic acid, and from N-protected amino acids.

For the purpose of preparing a polymeric mesh, either a composite or a gel, or preparing a derivative of a functional polymer, preferably the following combinations of subsequently introduced ingredients are applied:

In one preferred embodiment, in combination with any of the above and below embodiments, a polymer comprising at least one primary or secondary amino group, preferably a polyamine is reacted with at least one acid or ester, or combinations thereof, either mono-valent or at least bivalent.

In a further embodiment, in combination with any of the above and below embodiments, a polymer comprising at least one hydroxyl group per molecule, preferably a polyalcohol is reacted with at least one acid or ester, or combinations thereof, either monovalent or at least bivalent.

In another preferred embodiment, in combination with any of the above and below embodiments, a polymer comprising at least one acidic group per molecule, preferably a poly acid, is reacted with at least one compound bearing either amino, hydroxyl or thiol groups, or combinations thereof, either monovalent or at least bivalent.

In another preferred embodiment, in combination with any of the above and below embodiments, a polymer comprising at least one ester group, preferably a polyester, is reacted with at least one compound bearing amino, hydroxyl or thiol groups, either monovalent or at least bivalent.

In additional preferred embodiments, in combination with any of the above and below embodiments, compounds with at least two different functional groups like amino alcohols are also comprised.

In another preferred embodiment, in combination with any of the above and below embodiments, a polymer comprising at least one acidic group per molecule, preferably a poly acid, is reacted with at least one alcohol, thiol, or amine.

With respect to the above and below embodiments the reaction product is a mesh, comprising a cross-linked polymer, when the amine, the acid, the ester, the thiol, or the alcohol reagents are at least bi-valent. Derivatives are obtained with monovalent reagents.

### Accordingly Provides the Present Invention

a process for the synthesis of a polymeric mesh, whereas at least one functional polymer is immobilized with a cross-linker via generation of amide or ester bonds, whereas both components, functional polymer and cross-linker, are not activated and not comprising active groups.

Active group means a residue capable of spontaneous reaction preferably at ambient temperature. Examples are e.g. NHS-esters, preferably anhydrides, acid chlorides, or epoxides. Usually the relating reagents are commercially available, ready for the reaction.

For examples of activated groups see the above chapter emphasizing peptide chemistry. Such reagents are usually prepared shortly prior to application, because they are not stabile for longer storage or cannot be isolated at all.

In additional preferred embodiments, in combination with any of the above and below embodiments, the cross-linkers used for the immobilisation of said subsequently attached polymers are comprising any reagents known from the prior art, preferably the cross-linkers as listed above.

Preferred temperatures for the above or below derivatisation and/or cross-linking reactions with reactants not activated and not comprising active groups are between 40° C. and the lowest decomposition temperature of one of the materials to be used, more preferably between 80° C. and 250° C., most preferred between 110° C. and 180° C.

### Substances and Materials of the Present Invention Generated Using Compounds Neither Activated Nor Active.

Accordingly is the present invention providing a polymeric mesh comprising the reaction product of at least one functional polymer and an at least one bivalent reagent, characterized in that neither the functional polymer nor the reagent are comprising active or activated functional groups.

The mesh is either a composite or a gel without support material.

In preferred embodiments, in combination with the above and below embodiments, the reaction product is formed by a polymer comprising at least one primary or secondary amino group or hydroxyl group, and a reagent comprising at least one at least bivalent acid or ester.

In further preferred embodiments, in combination with the above and below embodiments, the reaction product is formed by a polymer comprising at least one acidic or ester group, and a reagent comprising at least one at least bivalent amine, thiol, or alcohol.

When the functional polymer is a polyamine, polyalcohol, a polythiol, or a co-polymer comprising at least two different functional groups, combining amino, hydroxyl, or thiol groups, the cross-linking/immobilisation reagent is preferably an at least bi-valent acid or ester.

When the functional polymer is a poly acid or a co-polymer comprising at least two different functional groups, combining carboxyl, sulfonyl, or phosphonyl groups, the cross-linking/immobilisation reagent is preferably an at least bi-valent alcohol or amine, or an amino alcohol.

When the functional polymer is a polyester or a co-polymer comprising at least one ester group, the cross-linking/immobilisation reagent is preferably an at least bi-valent alcohol or amine, or an amino alcohol.

The present invention is therefore providing reaction products of at least one immobilized functional polymer and at least one at least bivalent complementary cross-linker, together forming a porous gel, whereas both polymer and gel are neither activated nor comprising active groups.

The present invention is also comprising the reaction products of at least one support material, an immobilized functional polymer and an at least bivalent complementary cross-linker, together forming a porous composite material, whereas support, polymer and gel are neither activated nor comprising active groups.

Using porous support materials, the solutions of the polymer and the reagent are preferably introduced into the pores by soaking. Membranes, tissues, or any even surfaces are preferably dipped in the solution, or the solution is sprayed across the support.

Any coating techniques like dipping, spraying, or spinning are applicable.

The present invention is also providing the reaction of compounds comprising at least in part the chemical state of a salt.

Therefore, in preferred embodiments, in combination with the above and below embodiments, basic polymers like polyamines may be protonated to a certain degree before they are contacted with the cross-linking or the derivatisation reagent, or with the support material, or with the support material already coated with the ester or acidic cross-linker.

In preferred embodiments, in combination with the above and below embodiments, basic polymers like polyamines may be protonated to a certain degree before they are reacted with the derivatisation or the cross-linking reagent or with the support material, which is optionally coated with the ester or acidic cross-linker.

In further preferred embodiments, in combination with the above and below embodiments, acidic polymers like poly(acrylates) may be deprotonated to a certain degree before they are contacted respectively reacted with the basic cross-linker, with the basic derivatisation reagent, or with the support material, which is optionally coated with the basic cross-linker.

In one preferred embodiment, in combination with the above and below embodiments, also the basic cross linkers or derivatisation reagents may be protonated before contacted with the polymer, or in advance of the reaction.

The polymer is preferably comprising ester groups or acidic residues.

In one preferred embodiment, in combination with the above and below embodiments, also the acidic cross linkers or derivatisation reagents may be deprotonated before contacted with the polymer, or in advance of the reaction.

The protonation of basic reaction compounds, more specifically of the polymer, the cross-linker or derivatisation reagent, is preferably achieved by the adjustment of the respective pH of the solution using an acid, preferably a monobasic acid, more preferred hydrochloric acid. Preferred are also volatile acids, more preferred formic or acetic acid.

The deprotonation of acidic reaction compounds, more specifically of the polymer, the cross-linker or derivatisation reagent, is preferably achieved by the adjustment of the respective pH of the solution using a base, preferably a mono-valent base, more preferred sodium or potassium hydroxyde. Preferred are also volatile bases, more preferred ammonia or triethyl amine.

For the pH adjustment of the polymer, the cross-linker, and the derivatisation reagent also buffers or modifiers are applicable, preferably volatile ones, more preferred ammonium acetate, ammonium formate, or mixtures of triethyl amine with formic acid or acetic acid.

Volatile means that the respective reagent is evaporated at a temperature below 280° C., preferably below 200° C., more preferred below 180° C.

The concentration range of the respective bases, acids, buffers, or modifiers applied for the pH change is adapted to the concentration of the functional groups in the polymer, derivatisation reagent, or cross-linker. The degree of neutralisation or conversion is controlled by the measurement of the pH using preferably acid-base titration.

Accordingly is the present invention relating to a method of preparation of a composite, comprising a porous or non-porous support material, a cross-linker, and a functional polymer, preferably a basic polymer, more preferred a polyamine, characterized in that

a solution of said polymer exhibiting a pH between 0 and 14 is contacted with the surface of the support material, the solvent is partially, preferably to at least 10% of its initial quantity, or more preferably completely evaporated, a solution of an at least dibasic acidic cross-linker with a pH between 0 and 14 is subsequently attached, and the reactants are heated, whereas the solvent is optionally evaporated in part or completely.

The present invention is also relating to a method of composite preparation, comprising a porous or non-porous support material, a cross-linker, and a functional polymer, characterized in that

a solution of a functional polymer, preferably an acidic polymer, exhibiting a pH between 0 and 14 is contacted with the surface of the support material, the solvent is partially, preferably to at least 10% of its initial quantity, or more preferably completely evaporated, subsequently a solution of an at least bivalent basic cross-linker with a pH between 0 and 14 is attached, and the reactants are heated, whereas the solvent is optionally evaporated in part or completely.

Moreover is the present invention relating to a method of preparation of a composite, comprising a porous or non-porous support material, a cross-linker, and a cross-linkable polymer, characterized in that

a solution of an at least dibasic acidic cross-linker with a pH between 0 and 14 is attached to the surface of the support material, the solvent is evaporated (to at least 10% of its initial quantity), subsequently a solution of a basic polymer with a pH between 0 and 14 is attached, and the reactants are heated, whereas the solvent is optionally evaporated in part or completely.

The present invention is also relating to a method of composite preparation, comprising a porous or non-porous support material, a cross-linker, and a cross-linkable polymer, characterized in that

a solution of an at least bivalent basic cross-linker with a pH between 0 and 14 is attached to the surface of the support material, the solvent is partially (to at least 10% of its initial quantity), or completely evaporated, subsequently a solution of an acidic polymer with a pH between 0 and 14 is attached, and the reactants are heated, whereas the solvent is optionally evaporated in part or completely.

In further preferred embodiments, in combination with the above and below embodiments, the reaction partner of a protonated polyamine is an ester, and the reaction partner of a protonated derivatisation or cross-linking reagent comprising an amino group is a polyester.

In preferred embodiments, in combination with the above and below embodiments, after the first attachment step the solvent comprising the polymer or cross-linker is preferably evaporated to a residual amount between 0% and 50% of its initial quantity, more preferred to a degree below 10%, most preferred to a degree below 5%.

Solutions are preferably aqueous, more preferably made from water, optionally buffered or comprising salt and/or modifiers.

### Reaction of Ionic Polymers and Ionic Cross-Linkers.

Ionic polymers, ionic derivatisation reagents, and ionic cross-linkers are comprising at least one ionic or ionizable group.

When mixing salts of polyamines with an at least bivalent acidic cross-linker, or mixing salts of polymers comprising at least one carboxylic group with at least bivalent amines, unexpectedly no precipitation was observed within a wide pH range. In the context of the present application, the term basic polymer is a synonym for cationic, the term acidic polymer is a synonym for anionic properties.

Therefore, one important aspect of the present application is related to combinations of ionic polymers with a salt of ionic cross-linkers, alternatively to combinations of salts of ionic polymers and ionic cross-linkers, which are not protonated or deprotonated.

As long one of the reaction partners is present as a salt, neutralized by a counter ion, the immediate cross-linking via ionic forces is obviously suppressed.

The degree of solubility is apparently dependent of the kind of polymer, its molecular mass and concentration, as well as the pH and the concentration of ions. So it was found that 850 mM aqueous poly(vinylamin), Lupamin 90-95, of pH 9.5 did precipitate when equal volumes of 85 mM citric acid were added. On the other hand, 4 ml of a 500 mM solution of Lupamin 45-70 at pH 10 remained completely transparent after adding 2 ml of 50 mM succinic acid. In addition, the concentration of the cross-linker and the number of its reactive residues is an important parameter affecting solubility.

Therefore, it is necessary to determine the solubility of the polymer-cross-linker system case by case. Always when precipitation cannot be avoided, the two step procedure of cross-linking should be applied, as outlined in the above embodiments.

As soon as the counter ion is removed from clear solutions, the ionic cross-linking will start, usually generating solid material. Covalent cross-linking is preferably achieved while heating the mixed components or supplying oscillation, vibrational, or radiation energy.

The product of cross-linking within all the above and below embodiments is a polymeric mesh, comprising nano sized pores, preferably exhibiting a pore diameter between 0.5 nm an 5 μm, more preferred between 1 nm and 100 nm, most preferred between 2 nm and 50 nm.

In preferred embodiments, also in combination with any of the above and below embodiments,

the corresponding acids respectively bases of counter anions and counter cations are preferably volatile, more preferably volatile at temperatures above 60° C. and below 180°.

Among said counter ions within the above and below embodiments, ammonium and alkyl ammonium are preferred cations, acetate and formate are preferred anions.

Therefore the present application is also relating to a process,

wherein the corresponding acids respectively bases of cations or anions of said salts are preferably volatile and evaporated at temperatures above 60° C.

The below embodiments are related to mixtures of solid materials, preferably to mixtures of solutions, comprising the functional polymers and the cross-linkers, preferably comprising the respective salts of polymers and/or salts of cross-linkers.

In one preferred embodiment, also in combination with any of the above and below embodiments, a basic polymer, preferably a polyamine is mixed with a salt of an at least bivalent acid, preferably of a carboxylic acid, and the resultant mixture is then reacted, whereas a cross-linked polymer is formed.

In another preferred embodiment, also in combination with any of the above and below embodiments, a salt of a basic polymer, preferably of a polyamine, is mixed with an at least bivalent acid, preferably with a carboxylic acid, and the resultant mixture is then reacted, whereas a cross-linked polymer is formed.

Preferred basic polymers are listed above.

Within the above and below embodiments, succinic, glutamic, maleic, fumaric, malic, tartraric, citric acid are more preferred multivalent cross-linkers for basic polymers.

Therefore is the present application relating to

a process for the equipment of a support material, preferably of fibers, threads or particles, more preferably for the synthesis of a filter medium,
whereas at least one basic polymer is mixed with a salt of an at least bivalent acid, said mixture is contacted with the surface of the support material, and the basic polymer is immobilized by cross-linking.

Therefore is the present application also relating to

a process for the equipment of a support material, preferably of fibers, threads or particles, more preferably for the synthesis of a filter medium,
whereas a salt of at least one basic polymer is mixed with at least one bivalent acid, said mixture is contacted with the surface of the support material, and the basic polymer is immobilized by cross-linking.

In one also preferred embodiment, also in combination with any of the above and below embodiments, an acidic polymer, preferably comprising carboxylic groups, is mixed with a salt of an at least bivalent basic compound, preferably comprising primary or secondary ammonium groups, and the resultant mixture is reacted, whereas a cross-linked polymer is formed.

In another preferred embodiment, also in combination with any of the above and below embodiments, a salt of an acidic polymer, comprising preferably carboxylic groups, is mixed with an at least bivalent basic compound, preferably comprising primary or secondary amino groups, and the resultant mixture is then reacted, whereas a cross-linked polymer is formed.

Preferred acidic polymers are listed above.

Preferred multivalent bases, serving as a cross-linker, are comprising primary and secondary amines, more preferred are aliphatic diamines with 2 to 6 carbon atoms.

Therefore is the present application relating to

a process for the equipment of a support material, preferably of fibers, threads or particles, more preferably for the synthesis of a filter medium,
whereas at least one acidic polymer is mixed with a salt of an at least bivalent basic compound,
said mixture is contacted with the surface of the support material,
and the acidic polymer is immobilized by cross-linking.

Therefore is the present application also relating to

a process for the equipment of a support material, preferably of fibers, threads or particles, more preferably for the synthesis of a filter medium,
whereas a salt of at least one acidic polymer is mixed with at least one bivalent basic compound,
said mixture is contacted with the surface of the support material,
and the acidic polymer is immobilized by cross-linking.

The degree of cross-linking for a polymeric mesh, synthesized for the purpose of the present application and calculated from the molar ratio between the functional groups of the cross-linker and the polymer, should preferably not exceed 50%. Preferred are 2% to 40%, more preferred 5% to 30%, most preferred are 10% to 20%.

Within the above and below embodiments the degree of salt formation is the major critical parameter preventing precipitation. The necessary solubility is preferably achieved adjusting the pH.

A certain excess of the counter ion is advantageous to keep both compounds, polymer and cross-linker, dissolved.

In preferred embodiments, also in combination with any of the above and below embodiments, a salt of either a cationic or anionic polymer and a complementary anionic or cationic cross-linker are dissolved and reacted at temperatures between 60° and 250°, more preferred between 80° C. and 220° C., most preferred between 110° C. and 190° C., whereas the components are non-covalently, preferably covalently cross-linked.

Complementary in the context of the present application means that there are attracting forces between the reaction partners, e.g. between negatively and positively charged or polarized compounds.

The present application is thus relating to a process for the preparation of a polymeric mesh,

wherein at least one salt of a cationic polymer and at least one anionic cross-linker are reacted, comprising the steps
(i) dissolving and mixing the components, preferably in an aqueous solvent,
(ii) heating the solution at temperatures between 60° and 250°, more preferred between 80° C. and 220° C., most preferred between 110° C. and 190° C.,
(iii) optionally evaporating at least a part of the solvents, and
(iv) isolating the solid polymeric mesh.

The present application is also relating to a process for the preparation of a polymeric mesh,

wherein at least one salt of an anionic polymer and at least one cationic cross-linker are reacted, comprising the steps
(i) dissolving and mixing the components, preferably in an aqueous solvent,
(ii) heating the solution at temperatures between 60° and 250°, more preferred between 80° C. and 220° C., most preferred between 110° C. and 190° C.,
(iii) optionally evaporating at least a part of the solvents, and
(iv) isolating the solid polymeric mesh.

In preferred embodiments, also in combination with any of the above and below embodiments, a cationic or anionic polymer and a salt of a complementary either anionic or cationic cross-linker are dissolved and reacted at temperatures between 60° and 250°, more preferred between 80° C. and 220° C., most preferred between 110° C. and 190° C., whereas the components are non-covalently, preferably covalently cross-linked.

The present application is thus relating to a process for the preparation of a polymeric mesh,

wherein at least one cationic polymer and at least one salt of an anionic cross-linker are reacted, comprising the steps
(i) dissolving and mixing the components, preferably in an aqueous solvent,
(ii) heating the solution at temperatures between 60° and 250°, more preferred between 80° C. and 220° C., most preferred between 110° C. and 190° C.,
(iii) optionally evaporating at least a part of the solvents, and
(iv) isolating the solid polymeric mesh.

The present application is also relating to a process for the preparation of a polymeric mesh,

wherein at least one anionic polymer and at least one salt of a cationic cross-linker are reacted, comprising the steps
(i) dissolving and mixing the components, preferably in an aqueous solvent,
(ii) heating the solution at temperatures between 60° and 250°, more preferred between 80° C. and 220° C., most preferred between 110° C. and 190° C.,
(iii) optionally evaporating at least a part of the solvents, and
(iv) isolating the solid polymeric mesh.

The present application is also relating to the reaction product of a salt comprising a cationic polymer and an anionic cross-linker.

The present application is also relating to the reaction product of a salt comprising an anionic polymer and a cationic cross-linker.

The present application is also relating to the reaction product of a cationic polymer and a salt comprising an anionic cross-linker.

The present application is also relating to the reaction product of an anionic polymer and a salt comprising a cationic cross-linker.

In also preferred embodiments, also in combination with any of the above and below embodiments, salts of the respective polymers or solutions thereof are mixed with salts or salt solutions of the various cross-linkers and reacted.

Alternatively salts of the respective polymers are dissolved in solutions comprising salts of the various cross-linkers.

Alternatively salts of the various cross-linkers are dissolved in solutions comprising salts of the respective polymers.

Therefore is the present application relating to a process for the preparation of a polymeric mesh,

wherein at least one solid or dissolved salt of a cationic polymer and at least one solid or dissolved salt of an anionic cross-linker are reacted, comprising the steps
(i) mixing the components or the solutions of components,
(ii) heating the solution,
(iii) optionally evaporating at least a part of the solvents, and
(iv) isolating the solid polymeric mesh.

The present application is also relating to the reaction product of a salt comprising a cationic polymer and a salt comprising an anionic cross-linker.

Moreover is the present application also relating to a process for the preparation of a polymeric mesh,

wherein at least one solid or dissolved salt of a anionic polymer and at least one solid or dissolved salt of a cationic cross-linker are reacted, comprising the steps
(i) mixing the components or the solutions of components,
(ii) heating the solution,
(iii) optionally evaporating at least a part of the solvents, and
(iv)isolating the solid polymeric mesh.

The present application is also relating to the reaction product of a salt comprising an anionic polymer and a salt comprising a cationic cross-linker.

In preferred embodiments, also in combination with any of the above and below embodiments, the volatile free acid or base of a counter ion like ammonium or acetate is evaporated.

In preferred embodiments, also in combination with any of the above and below embodiments, it is possible to mix the salt of the polymer with the cross-linker in a solution, or the salt of the cross-linker with the polymer in a solution, or the salt of the cross-linker with the salt of the polymer in a solution, without ionic or co-valent cross-linking between these partners at temperatures below 100° C., preferably below 60° C., more preferably below 30° C.

Accordingly is the present application relating to a

solution comprising a mixture of a salt of a cationic or anionic polymer and a complementary, either anionic or cationic cross-linker.

In addition, is the present application relating to a

solution comprising a mixture of a cationic or anionic polymer and a salt of a complementary, either anionic or cationic cross-linker, characterized in that the components remain soluble, and are not cross-linked by ionic interactions.

Moreover is the present application relating to a

solution comprising a mixture of a salt of a cationic or anionic polymer and a salt of a complementary, either anionic or cationic cross-linker, characterized in that the components remain soluble, and are not cross-linked by ionic interactions.

Together with the proceeding cross-linking reaction, a polymeric mesh is generated, becomes solid, but remains porous.

Within further embodiments, also in combination with the above and below embodiments, a reaction mixture is either solid or liquid, preferably a solution of the polymer and the cross-linker, more preferably an aqueous solution, optionally comprising between 0% and 20% of an organic, water-miscible solvent, preferably acetone, THF, dioxane, DMF, ethanol, i-propanol, or methanol.

Solid mixtures of polymers and cross-linkers comprising at least one counter ion, preferably capable of releasing a volatile acid or base, may also be cross-linked at high temperature, preferably above 120° C.

Within any of the above and below embodiments the reaction of cross-linking and derivatisation is preferably achieved with the supply of thermal, oscillation, vibrational, or radiation energy, using e.g. an oven, a microwave oven, an ultrasonic bath, and any irradiation techniques as known from the prior art, preferably at temperatures between 60° and 250°, more preferred between 80° C. and 220° C., most preferred between 110 and 190° C.,

The energy input may be performed under increased pressure, reduced pressure or in vacuo.

Within further preferred embodiments, also in combination with the above and below embodiments, the polymeric mesh is prepared on a surface, more preferred on the surface of a support material, most preferred on the surface of fibers, threads, or particles.

Accordingly is the present application related to a process

wherein the polymeric mesh is prepared on the surface of a support material, preferably on the surface of fibers, threads or particles, comprising the steps of
(i) contacting the mixture or solution of polymer and cross-linker with the support material,
(ii) optionally removing excess solution,
(iii) reacting the components,
(iv) isolating the resultant composite material.

Excess solution is preferably removed by aspiration, squeezing, evaporation, or a combination thereof.

Within further preferred embodiments, also in combination with any of the above and below embodiments, composites, preferably filter media are prepared, contacting said mixtures of polymer and cross-linker with the support material, whereas the reaction between polymer and cross-linker is started afterwards.

Fibers, threads or particles may be porous, too, exhibiting an external surface together with an internal surface, attributed to said pores.

In combination with any of the above and below embodiments, the reaction time between the functional polymer and the complementary cross-linker or the complementary derivatisation reagent is preferably between 0.1 seconds and 8 hours, more preferably between 1 second and 10 minutes, most preferred between 2 seconds and 20 seconds.

In one preferred embodiment, also in combination with any of the above and below embodiments, the reaction of the mixture of polymer and cross-linker with the support material, preferably a tissue or fabric, takes place between the surface of heated plates, preferably between rotating drums, more preferred in a roller drying chamber, whereas the contact time between the heated surfaces, e.g. a single pair of rollers is preferably below 5 seconds, more preferred below two seconds.

Within additional preferred embodiments, also in combination with any of the above and below embodiments, the reaction takes places during the contact with a multitude of rollers, preferably positioned in a row, whereas the temperature is either constant at a level of preferably between 60° C. and 250° C., or is increasing from a level between 60° C. and 80° C. at the inlet of the drying device to a level between 180° C. and 250° C. at the outlet.

Accordingly, is the present application relating to

a process for the preparation of a polymeric mesh, whereas the contact time with a particular heating device is below one minute, preferably below 10 seconds, more preferred below five seconds, most preferred below two seconds.

The present application is thus relating to

a process for the preparation of a polymeric mesh or a composite material, preferably a filter medium, whereas the reaction time between polymer and cross-linker and optionally also with the support material is below 10 seconds.

### Additional Embodiments of Derivatisation, Using Reagents, not Active and not Activated

Said stepwise thermal ester, thioester or amide formation is preferably used for the derivatisation of a functional polymer, preferably of a polymeric mesh, more preferred for the derivatisation of composite materials comprising functional polymers also in combination with any of the above or below embodiments.

Accordingly is the present application relating to a method of derivatisation of a composite, comprising a porous or non-porous support material and an immobilized, preferably cross-linked basic polymer or a salt of said polymer, whereas the composite material is optionally dry, characterized in that

a solution of an aromatic, aliphatic, or araliphatic carboxylic, sulphonic, or phosphonic acid is added, exhibiting a pH between 0 and 14, and the reactants are heated, whereas the solvent is optionally evaporated in part or completely.

The acid is comprising functional groups, aliphatic, araliphatic or aromatic or heterocyclic residues, optionally substituted, e.g. with alkoxy groups like in anisic acid. Preferred are the acids as listed above.

Alternatively is the derivatisation reagent an ester.

Accordingly is the present application also relating to a method of derivatisation of a composite, comprising a porous or non-porous support material and an immobilized, preferably cross-linked acidic polymer or salt of said polymer, whereas the composite material is optionally dry, characterized in that

a solution of a primary or secondary amine with a pH between 0 and 14 is attached, and the reactants are heated, whereas the solvent is optionally evaporated in part or completely.

The present application is also relating to a method of derivatisation of a composite, comprising a porous or non-porous support material and an immobilized, preferably cross-linked polyester, whereas the composite material is optionally dry,

characterized in that
a solution of a primary or secondary amine with a pH between 0 and 14 is attached, and the reactants are heated, whereas the solvent is optionally evaporated in part or completely.

Applicable are any aliphatic, aromatic and heterocyclic primary or secondary amines, preferably benzyl amine, phenyl ethylamine, naphthyl ethylamine, catecholamines like, histamine, lysine and its ester derivatives, glucosamine, also comprising the related chiral compounds.

Accordingly is the present invention relating to a method of derivatisation of a composite, comprising a porous or non-porous support material and an immobilized, preferably cross-linked acidic polymer or a salt of said polymer, whereas the composite material is optionally dry,

characterized in that
a solution of a primary or secondary alcohol with a pH between 0 and 14 is attached, and the reactants are heated, whereas the solvent is optionally evaporated in part or completely.

Preferred alcohols for the purpose of cross-linking or derivatisation are aromatic, aliphatic and phenolic compounds, more preferred is benzyl alcohol, N-protected threonine and serine, and polyvalent alcohols like ethylene glycol, glycerine, or sugars, inclusive di- and polysaccharides.

Accordingly, is the present application also relating to the derivatisation of an acidic or basic polymer with a salt of an at least bivalent basic or acidic cross-linker. Moreover is the present application relating to the derivatisation of a salt of an acidic or basic polymer and an at least bivalent basic or acidic cross-linker.

Finally is the present application relating to the derivatisation of a salt of an acidic or basic polymer with a salt of an at least bivalent basic or acidic cross-linker

In preferred embodiments, in combination with the above and below embodiments, the materials, their use and the related synthesis methods of the present application are also suitable for various usage in the area of liquid treatment, in particular substance separation and purification.

Wet-Laid Materials and their Preparation.

One important class of filter media is manufactured in a wet-laid process.

Wet laid processes for the production of filter media are starting from small fibers and a binder or adhesive, whereas the fibers are glued together, preferably at enhanced temperatures thus forming porous paper sheets or paper webs. These prior art filter media are effective for the removal of fine particles. The related filter classes are ranging from M5-M6, F 7-F9 acc. EN 779 and H10-H12 acc. EN 1822.

For the application in such wet laid processes the present application is introducing polymeric adhesives, forming a nano-porous mesh, thus capable of adsorbing undesired compounds from gasses and liquids, mainly hazardous substances, preferably comprised in aerosols.

In one preferred embodiment, also in combination with the above and below embodiments, a functional polymer is used as an adhesive (binding agent, binder) for particles, preferably for the support materials as listed above and below, more preferably for fibers, thus generating a composite material, comprising a “polymeric mesh adsorbent” present inside and between the immobilized polymer coils and globules, and, in addition, a second web or sieve, due to the space left between the support material fibers or particles.

The present invention is thus related to a filter medium comprising fibers, particles, or fibers together with particles, and a functional polymer as an adhesive.

In another preferred embodiment, also in combination with the above and below embodiments, said functional polymer is an adsorbent for dust, aerosols, and hazardous compounds, preferably allergens.

Within a more preferred embodiment, in combination with the above and below embodiments, the functional polymer adhesive is combined with a cross-linking agent allowing to glue the fibres and/or particles together, thus forming a mechanically and thermally stable composite filter medium, exhibiting a web with a pore size between 50 nm and 1 mm, preferably between 200 nm and 100 μm, more preferred between 1 μm and 50 μm, whereas the support fibers and/or particles are coated with the cross-linked, preferably nano-porous layer of the polymer. The pore size of the relating filter medium is determined according to ASTM F316-03.

Moreover, the porous polymeric mesh of said composite material of the above and below embodiments is comprising pores in a nanometer range, due to the space available inside and between the immobilized coils and globules of the functional polymer.

In combination with any of the above or below embodiments, these nanopores of said polymeric mesh are exhibiting an upper, but variable pore size radius Rₕᵢ, thus capable of retaining a significant amount of compounds with a hydrodynamic radius below this exclusion limit Rₕᵢ (nm) inside the pore volume. Rₕᵢ ranges preferably below 20 nm, more preferred below 10 nm, most preferred below 6 nm.

This hydrodynamic pore radius is preferably determined using composite particles as described in the chapter methods. The porosity of fabrics and threads, however, is preferably investigated determining the partitioning coefficient of the individual pullulane standards. In this case the pullulane portion excluded from the polymeric mesh is quantitatively measured applying a separate size exclusion chromatography, also used for the characterization of the standards. For practical purposes it is sufficient to determine the degree of exclusion using several proteins of known molecular mass and hydrodynamic radius.

Accordingly, said adhesive, comprising a polymer and preferably a cross-linker, works also as an adsorbent, binding compounds as listed above, preferably harmful substances like allergens. These substances are depleted from liquids and gases, achieved by contacting the filter material with the flowing or stationary medium. The liquids are aqueous or organic. The preferred gas is air.

The present application is thus related to a filter medium comprising fibers, particles, or fibers together with particles, and a functional polymer together with a cross-linking agent, the functional polymer together with the cross-linker functioning as an adhesive for the solid support materials.

Moreover is the present application related to a filter medium, wherein short fibers or small particles are connected with/by a (cross-linked) mixture of a functional polymer and a cross-linking agent.

Within preferred embodiments, also in combination with the above and below embodiments, the binding agent is a basic polymer, preferably an amino group containing polymer, more preferred poly(allylamine) or poly(ethyleneimine), most preferred poly(vinylamine) or co-polymers thereof with vinyl formamide, preferably in applied in combination with a cross-linker from the above and below selection.

The cross-linker for basic polymers is preferably a multivalent epoxide, more preferably an epoxide soluble in water, most preferred poly(ethylene glycol diglicidylether).

Within further preferred embodiments, in combination with the above and below embodiments, an at least bivalent acid, more preferred a carboxylic acid is used as a cross-linker.

More preferred are combinations of basic polymers, their salts and multivalent acids or salts thereof, as outlined within the above and below embodiments. Said salt anions and cations are preferably derivatives of volatile acids or bases as outlined in the above chapter.

Within additional preferred embodiments, in combination with the above and below embodiments, the cross-linker for the basic polymeric binding agent is also a polymer, comprising acidic residues as listed above, or salts thereof, preferably carboxylic, but also anhydride groups.

Poly(maleic anhydride) and copolymers thereof are the most preferred anhydrides.

In one preferred embodiment, also in combination with the above and below embodiments, the binding agent is a polymer comprising acidic residues as listed above, preferably carboxylic groups, preferably in combination with a cross-linker from the above and below selection.

Within further preferred embodiments, in combination with the above and below embodiments, an at least bivalent amine is used a cross-linker for a polymer comprising acidic residues.

More preferred are combinations of acidic polymers, their salts and multivalent bases or salts thereof, as outlined within the above embodiments.

Said salt cations and anions are preferably derivatives of volatile bases or acids as outlined in the above chapter.

Within another preferred embodiment, also in combination with the above and below embodiments, the binding agent is a polymer comprising anhydride residues as listed above, preferred is poly(maleic anhydride) and copolymers thereof, preferably in combination with a cross-linker containing at least two primary or secondary amino groups, hydroxyl groups, or thiol groups.

Within additional preferred embodiments, in combination with the above and below embodiments, the cross-linker for the acidic polymeric or anhydride groups containing binding agent is also a polymer, comprising basic residues as listed above, or salts thereof, preferably primary or secondary amine.

Accordingly is the present application relating to materials and to a process, wherein each molecule of the functional polymer is comprising at least one primary or secondary amino group or at least one carboxylic group.

Moreover is the present application relating to materials and to a process for the synthesis of said materials, wherein the cross-linker is comprising at least two primary or secondary amino groups or at least two carboxylic groups, complementary to the carboxylic group and primary or secondary amino group of the functional polymer.

The present application is therefore related to a filter medium, whereas the functional polymer and the cross-linker are covalently bonded via at least one amino, or/and amide or/and ester or/thioester bond.

Fibres of the present invention are solid, thin materials, preferably made from glass or from polymers.

Within preferred embodiments, in combination with the above and below embodiments, the preferred diameter of the fibers is between 0.1 μm and 100 μm, with respect to filter media made with a wet-laid process. The more preferred diameter of glass fibers is between 0.1 μm and 20 μm. The more preferred diameter of synthetic polymer fibers is between 2 μm and 30 μm.

Within preferred embodiments, in combination with the above and below embodiments, the fiber length is between 20 μm and 60 mm. The length of glass fibers is preferably between 50 μm and 10 mm, the length of polymeric fibers is preferably ranging between 3 mm and 30 mm.

Accordingly is the present application relating to a composite material, preferably a filter medium, wherein short fibers are connected with/by a (cross-linked) mixture of a functional polymer and a cross-linking agent.

Within preferred embodiments, in combination with the above and below embodiments, mixtures of fibers are used in order to serve as a support material with enhanced stability and/or elasticity. When the majority of fibers is comprising glass materials, it is advantageous to add amounts between 0.5% and 3% of polymeric fibers in order to improve the stability and the elasticity of the resultant web.

Support materials are used as listed above. Particles are preferably made from silica or activated carbon, fibers preferably from glass or polyester.

Within preferred embodiments, in combination with the above and below embodiments, the particle size of the particles incorporated in a composite material is preferably below 20 mm, more preferred below 2 mm, and most preferred below 500 μm.

Within an additional preferred embodiment, in combination with the above and below embodiments, also nanoparticles with diameters preferably between 0.5 nm and 500 nm are connected with functional polymers. Examples are fullerenes or noble metals like nano sized gold.

Particle materials are preferably porous, exhibiting preferably a specific surface area above 100 m² per gram, and a pore volume above 0.5 ml per gram. Any organic or inorganic materials are applicable, preferred are particles made from materials of the above list, more preferred made from poly(acrylic acid), poly(methacrylic acid), poly(acrylamide), poly(methacrylamide), alumina, silica, and activated carbon.

Within additional preferred embodiments, in combination with the above and below embodiments, a support material, preferably comprising fibers and/or particles, is suspended in a liquid medium, then precipitated and aspirated on a sieve or a frit. The solid, preferably moist residue is contacted with a reagent solution or suspension, comprising a functional polymer and a cross-linker, then excess liquid is aspirated, the solid layer is dried, and heated at a temperature between 60° C. and 240° C., preferably between 80° C. and 190° C.

Due to the interactions between the functional polymer, the complementary cross-linker, and the support material, a web is generated, comprising the empty space left between the support fibers and particles. Simultaneously a polymeric mesh is formed on the surface of the support material fibers and particles, or combinations of fibers and particles. Said composite material thus exhibits two different porosities, comprising the nano sized mesh of the cross-linked functional polymer and the web with larger space between to the interconnected particles or fibers. The relevant pore diameter ranges of both morphologies are cited above.

The present invention is therefore related to a process, preferably to a wet-laid process for the production of filter media, comprising the steps of
(i) suspending fibers or/and particles, the precursor materials of the support material, in a liquid,
(ii) precipitating and optionally aspirating a layer comprising these precursors of a support material on a sieve, a frit, or other rigid porous basis,
(iii) then contacting this precipitated layer with a reagent solution or suspension comprising a functional polymer and a cross-linker for a sufficient time, allowing the adsorption of the reagents on the support surface,
(iv) optionally aspirating excess liquid through the sieve or frit, and
(v) drying and heating the solid layer until the functional polymer is immobilized on the surface of the support material.

The preferred products of the above process are filter media, preferably starting materials for filter elements, capable of adsorbing various compound from liquids and gasses. The chemical structure of the polymer used, in particular its functional groups, are selected in advance according to the rules of complementary interaction, thus enabling a selective strong binding of target compounds.

Within alternative preferred embodiments, in combination with the above and below embodiments, the functional polymer is added and adsorbed by the fibers or particles already during step (i), whereas the reagent solution of step (iii) is only comprising the cross-linker, and wherein the steps (ii), (iv), and (v) remain unchanged as described in the above embodiment.

Alternatively within further preferred embodiments, in combination with the above and below embodiments, the cross-linker is added and adsorbed by the fibers and/or particles already during step (i), whereas the reagent solution of step (iii) is only comprising the functional polymer, and wherein the steps (ii), (iv), and (v) remain unchanged as described in the above embodiment.

Finally, within further preferred embodiments, in combination with the above and below embodiments, the cross-linker and the functional polymer are added and adsorbed by the fibers and/or particles already during step (i), this precursor of the composite material is then precipitated and aspirated on a sieve or a frit during step (ii), and the resulting dried solid layer is heated, until the functional polymer becomes immobilized on the surface of the support material.

Preferred are the support materials, functional polymers and cross-linkers as listed in the above and below chapters.

Most preferably is the process for the production of wet-laid materials relating to fibers made from glass, polyester or poly(vinyl alcohol) and to particles made from glass, silica, alumina, or activated carbon.

Within preferred embodiments, in combination with the above and below embodiments, the fibers are mixed with porous or non-porous particles during step (i), allowing the synthesis of filter materials exhibiting high surface values and thus an enhanced binding capacity. Any combination of the fibers and particle materials from the above and below lists are applicable. Preferred examples of such mixtures, without any limitation of the broad selection range, are: glass fibers together with silica gel or with activated carbon or derivatives thereof; polyester fibers together with derivatives made from activated carbon; or combinations thereof.

The present application is therefore related to a

composite material comprising the following components: at least one functional polymer or a derivative of a functional polymer, at least one cross-linker and at least one kind of fibers, particles, alternatively a mixture of fibers together with particles.

Moreover is the present application relating to a process for the preparation of the above composite material, wherein fibers, particles, or fibers together with particles are connected by adhesives/binders comprising at least one functional polymer and at least one cross linker.

The present application is also relating to the above composite material, wherein the fibers, particles, or fibers together with particles are connected by adhesives/binder comprising at least one functional polymer and at least one cross linker, leaving open space between the connected support components, thus generating a web exhibiting the pore size range of the composite materials as defined above.

Within additional preferred embodiments, in combination with the above and below embodiments, a combination of functional polymers is applied, preferably comprising at least one neutral and one cationic or anionic compound, more preferred at least one basic and at least one acidic component. Preferred examples of neutral polymer compounds are poly(vinyl acetate), poly(vinylalcohol), poly(acrylates), and poly(methacrylates).

Each functional polymers and cross-linker of the above and below embodiments is either applied as a solution, as a liquid or as a solid material.

Within preferred embodiments, in combination with the above and below embodiments, the functional polymer of the above manufacturing process is comprising at least one basic residue, more preferred at least one primary or secondary amino group.

Alternatively is the functional polymer preferably comprising at least one acidic residue, more preferred at least one carboxylic group.

Within preferred embodiments, in combination with the above and below embodiments, the cross-linker of the above manufacturing process is comprising either at least two acidic residues or at least two basic residues, complementary with the basic respectively acidic residues of the functional polymer. The basic residues are preferably primary or secondary amino groups. The acidic residues are preferably carboxylic groups.

The functional polymers and the cross-linkers are preferably not activated and not comprising active groups, more preferably the acids or bases are applied as a salt.

The present application is therefore related to the design of a filter medium, filter element, or filter arrangement for the filtration of gasses or liquids comprising at least one of the above or below composite materials.

Filter media, produced according to a wet-laid manufacturing process, are preferred, comprising at least one sort of fibers, and at least one binder, and at least one cross-linker, whereas said binder is comprising at least one functional polymer or derivative of a functional polymer.

Within preferred embodiments, in combination with the above and below embodiments, the composite materials or filter media, manufactured in a wet-laid process as described above, are used for the removal of contaminants, preferably proteins, glycoproteins, lipoproteins, RNA, DNA, oligonucleotides, oligosaccarides, polysaccarides, lipo poly(saccharides), other lipids, and phenolic compounds, more preferably comprised in an aerosol or in dust, from a liquid or a gas, characterized in that the liquid or the gas, containing said contaminants is contacted with at least one of said composite material, filter medium, filter element, or filter arrangement comprising at least one immobilized functional polymer or derivative of a functional polymer.

Within preferred embodiments, in combination with the above and below embodiments, the liquid or gas is flowing through the composite materials or filter media.

Within preferred embodiments, in combination with the above and below embodiments, the purified liquid or gas is removed or separated from said composite materials or filter media.

Within preferred embodiments, in combination with the above and below embodiments, the composite materials or filter media, manufactured in a wet-laid process as described above, are comprising a functional polymer bearing at least one basic residue.

Within preferred embodiments, in combination with the above and below embodiments, said basic residue is comprising at least one primary or secondary amino group.

Within preferred embodiments, in combination with the above and below embodiments, the composite materials or filter media, manufactured in a wet-laid process as described above, are comprising a functional polymer bearing at least one acidic residue.

Within preferred embodiments, in combination with the above and below embodiments, said acidic residue is comprising at least one carboxylic group.

Said filter media of the above and below embodiments are capable of the depletion of contaminants from liquids and gasses.

Therefore is the present application related to filter elements and to purification processes, wherein the functional polymer of filter media is comprising at least one primary or secondary amino group or at least one carboxylic group.

Accordingly is the present application related to a method for the removal of contaminants from a liquid or a gas,

characterized in that at least one filter, or a filter element, or a filter arrangement comprising at least one of said wet-laid filter media, is contacted with said liquid or gas thus depleting at least one of said contaminants.

Said wet-laid filter medium is preferably comprising at least one cross-linked polymer with at least one basic or acidic residue.

Within preferred embodiments, in combination with the above and below embodiments, a filter medium made in a wet-laid process is adsorbing contaminants from a liquid.

Thus is the present application also relating to a purification method, wherein a filter medium made in a wet-laid process is used, and wherein the functional polymer comprised in the filter medium is adsorbing contaminants from a liquid.

Within preferred embodiments, in combination with the above and below embodiments, the liquid is comprising an organic medium, preferably a lubricant, fuel or oil, more preferred a biofuel or an already used and therefore impure lubricant or oil, optionally together with a solvent.

The present application is therefore also relating to a method for the removal of contaminants from biological liquids like fermentation broths, and from the final products of fermentation like biofuels. Said contaminants are preferably comprising degradation products of plants, animal tissue, algae, microorganisms, in particular of proteins, glycoproteins, lipoproteins, RNA, DNA, oligonucleotides, oligosaccarides, polysaccarides, fat, lipids, and phenolic compounds, or their degradation products.

Basically is the gas or liquid either contacted with a filter medium in a static mode, or the gas or liquid is passing the filter medium with a certain flow rate, or both methods, static and dynamic, are combined over the course of time.

In addition, one side of each filter medium is contacted first by the liquid or gas. Provided that at least two filter media are combined in a row, a first one is exposed to the liquid or gas earlier than the residual filter media.

Accordingly is the present application relating to a purification method, wherein the liquid or gas is flowing through the composite materials or filter media. Alternatively is the purification carried out in a static mode.

The present application is also relating to a purification method, wherein the purified liquid or gas is removed or separated from said composite materials or filter media after the depletion of the at least one contaminant.

Within further preferred embodiments, in combination with the above and below embodiments, the liquid or gas containing said contaminants is contacted with at least one combination of filter media, filter elements, or filter arrangements comprising at least two different filter media, whereas at least one filter medium (polymeric mesh adsorbent or composite material) is comprising an immobilized cross-linked polymer, containing at least one basic residue, and the other one is comprising an immobilized cross-linked polymer, containing at least one acidic residue.

Said at least two filter media are comprised in at least one filter element, preferably allocated to at least two filter elements. The order of said filter media in a filter element and the order of filter elements in a filtration process is arbitrary, and may be freely chosen according to the requirements of the particular purification task. Within also preferred embodiments, in combination with the above and below embodiments, an arbitrary number of filter media comprising a polymeric mesh of the present application may be combined with filter media not comprising a polymeric mesh of the present application. Also the sequence of installation is arbitrary.

Basic residues of the above combination are preferably comprising at least one primary or secondary amino group, acidic residues are preferably comprising at least one carboxylic group.

Accordingly is the present application related to a method for the removal of contaminants from a liquid or a gas,

characterized in that the liquid or the gas containing said contaminants is contacted with at least one combination of filter media, filter elements, or filter arrangements comprising at least two different filter media, preferably composite materials, whereas one filter medium is comprising an immobilized polymer, containing at least one basic residue, and one other is comprising an immobilized polymer, containing at least one acidic residue.

Accordingly is the present application related to a combination of filter media, filter elements, or filter arrangements, comprising at least two different filter media, preferably composite materials, containing at least one cationic polymer and at least one anionic polymer.

Within preferred embodiments, in combination with the above and below embodiments, the liquid or the gas is contacted first with the filter medium comprising basic residues and subsequently with the filter medium comprising acidic residues. Accordingly is the present application related to a method for the removal of contaminants from a liquid or a gas, wherein the liquid or the gas is contacted first with the filter medium comprising basic residues.

Within preferred embodiments, in combination with the above and below embodiments, the liquid or the gas is contacted first with the filter medium comprising acidic residues and subsequently with the filter medium comprising basic residues. Accordingly is the present application related to a method for the removal of contaminants from a liquid or a gas, wherein the liquid or the gas is contacted first with the filter medium comprising acidic residues.

Within preferred embodiments, in combination with the above and below embodiments, a filter medium or a filter element comprising a polymeric mesh adsorbent, containing at least one of the below or above functional polymers, is combined with at least one filter, filter material, or filter element not equipped with said functional polymers of the present application, preferably with products commercially available.

Accordingly is the present application related to a filter element or to a method for the removal of contaminants from a liquid or a gas, wherein the at least one filter medium is part of one filter element, comprising at least one additional filter material or at least one laminate or overlay, not containing a polymeric mesh.

In addition is the present application related to an arrangement of filter elements, whereas at least one of them is comprising a filter medium comprising a polymeric mesh.

### Abbreviations and Definitions

Partial volumes (μl), necessary in order to obtain the porosity data of a polymeric mesh adsorbent, measured with a packed chromatographic column by injecting molecular standards of defined hydrodynamic radii Rₕ. The volumes have been determined by multiplying the signal time with the flow rate.

### Vₑ

The net elution volume Vₑ is obtained when the extra column volume of the chromatographic system has been subtracted from the gross elution volume. Vₑ is identical to the total void volume of a column Vₒ. Vₑₙ is the elution volume of an individual standard n.

### Vₒ

The total void volume of a column is the sum of the pore volume Vₚ and the interstitial volume Vᵢ.

### Vᵢ

The interstitial volume Vᵢ is the volume between the particles.

### Vₚ

The pore volume Vₚ of the adsorbent is comprising the total porous space.

### Materials

### Support Material

Silica Gel Davisil LC 250 (W.R. Grace), average nominal pore size 250 Å, particle size 40-63 μm (lot: 1000241810).

Eurosil Bioselect 300-5, 5 μm, 300 Å, Knauer Wissenschaftliche Geräte, Berlin, Germany.

Fabric sheets 29.6 cm×21.0 cm, PBS 290 S and LD 7260TW, Freudenberg Filtration Technologies, Weinheim, Germany.

Fiber specifications B 39, B 06, and EC 06, Lauscha Fiber International, Lauscha, Germany.

### Polymers

Poly(vinylformamid-co-polyvinylamin) solution in water, Lupamin 45-70 (BASF) supplier: BTC Europe, Monheim, Germany, partially hydrolysed for the embodiment of Example 1 by heating 1000 g of Lupamin 45-70 with 260 g of sodium hydroxide (10% w/v) at 80° C. over five hours. Finally the pH was adjusted to 9.5 with 170 g of a 10% hydrochloric acid.

For Examples 1a, 6, and 7 the untreated Lupamin 45-70 solution was used without sodium hydroxide hydrolysis and hydrochloric acid pH adjustment.

Degree of hydrolylisis according to the information of the supplier 70%, equal to a 30% formyl concentration. The average molecular mass of a monomer unit is calculated to Mₘₒₙₒ 51 Da. According to the CHN analysis the polymer content was 130 g/l (monomer concentration 2.55 mol/l).

Poly(vinylamin) solution in water, Lupamin 90-95 (BASF), supplier: BTC Europe, Monheim, Germany. This polymer solution was the starting material of Examples 2, 2a, 3, 4, and 5.

Degree of hydrolylisis according to the information of the supplier 95%, equal to a 5% residual formyl concentration. The average molecular mass of a monomer unit is calculated to Mₘₒₙₒ 43 Da. According to the CHN analysis the polymer content was 62 g/l (monomer concentration 1.45 mol/l).

### Cross-Linker

Hexanediol diglycidyl ether, Ipox RD 18, ipox chemicals, Laupheim (Germany)—lot: 16092).

Poly(ethylene glycol) diglycidyl ether, average Mₙ 500, Sigma Aldrich, Schnelldorf, Germany.

### Chemicals

Citric acid monohydrate (M=210 g), Merck KGaA, Darmstadt, Germany

### Equipment

Sheet former from Estanit GmbH, Mulheim/Ruhr, Germany

### Methods

### Determination of the Pore Size Distribution and of the Pore Volume Fractions of Composite Adsorbents

The accessible pore volume fractions, which are correlated to the pore diameters and the exclusion limits for polymer molecules with various hydrodynamic radius have been determined using inverse Size Exclusion Chromatography (iSEC). For this purpose, the composite material was packed into a 1 ml (50×5 mm) chromatographic column, equilibrated with 20 mM aqueous ammonium acetate buffer, pH 6, and calibrated by applying two low molecular weight standards, and a selection of six commercial pullulane polymer standards of known defined average molecular weights M_{w} (PPS, Mainz Germany, for details see Fig. Embodiments 1.1 and 1.2).

The M_{w} determination of the pullulane standards was achieved at PSS by SEC with water, sodium azide 0.005% as mobile phase at a flow rate of 1 ml/min at 30° C. Three analytical columns, each 8×300 mm (PSS SUPREMA 10 μm 100 Å/3000 Å/3000 Å), have been used in in-line combination with an 8×50 mm pre-column (PSS SUPREMA 10 μm). Sample concentration was 1 g/l, injected volume 20 μl in each run. Detection was achieved with a refractive index (RI) monitor (Agilent RID), connected to a PSS WinGPC Data Acquisition system.

The pore volume fraction Kₐᵥ, accessible for the particular standards in a particular composite material, was obtained by evaluation of the net elution volume Vₑₙ (μl).

Accordingly, Kₐᵥ describes the fraction of the overall pore volume, a particular standard with given hydrodynamic radius Rₕ can access. Methanol is used for the determination of the total liquid volume Vₜ=Vₑ=V₀ representing a Kₐᵥ value of 1. The pullulane standard of 210,000 Da is used to determine the interstitial volume Vᵢ, between the packed composite particles, representing the liquid volume outside the particles, as it is already excluded from the pores (see also FIG. 1), thus representing a Kₐᵥ of 0 (0% of the pore volume). The difference between Vₒ and Vᵢ is the pore volume Vₚ.

| iSEC Standards | Rₕᵢ (nm) |
|---|---|
| Methanol | |
| Ethylene glycol | |
| Pullulan 6.2 kD | 2.13 |
| Pullulan 10 kD | 2.70 |
| Pullulan 21.7 kD | 3.98 |
| Pullulan 48.8 kD | 5.96 |
| Pullulan 113 kD | 9.07 |
| Pullulan 210 kD | 12.370 |

The partial pore volumes are defined as the respective volume fractions in the composite adsorbent, which can be accessed by not retained pullulane polymer standards, as well as by not retained smaller molecules. Not retained means, that in order to determine only the pore volume fractions, no interaction or binding of the respective standard occurs on the surface of a stationary phase. For the support material and the composites of the present invention this is the case for alcohols and hydrophilic carbohydrates, preferably pullulanes, exhibiting known hydrodynamic radii (Rₕ) in aqueous solvent systems.

The Rₕ values of the pullulanes have been calculated from the molecular weight M_{w} according to the empiric equation Rₕ=0.027 Mw^{0.5} (I. Tatarova et al., J. Chromatogr. A 1193 (2008), p. 130).

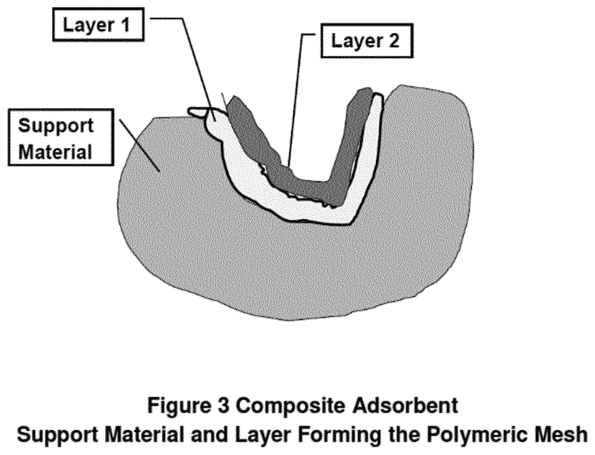

The Rₕ value of IgG was taken from the literature (K. Ahrer et al., J. Chromatogr. A 1009 (2003), p. 95, FIG. 4).

### EXAMPLES

### Example 1

### Preparation of a Particulate Composite Adsorbent

704 μl (658 mg) of hexane diol diclycidylether (Mw 230.2, d=1.07 g/ml) cross-linker were dissolved in 42 ml water. This cross-linker solution was added to 15 ml of an aqueous solution of poly(vinylformamid-co-polyvinylamin) (Lupamin 45-70, partially hydrolysed, see materials). After mixing, the pH of 11 was adjusted with 3 ml of 0.5 M NaOH.

10 g of Silica Gel Davisil LC 250, 40-63 μm (W. R. Grace), dry powder, were sedimented into a flat bottom stainless steel dish with 8 cm diameter. The bed height was 8 mm. 39.5 g of the polymer-cross-linker solution were added and equally distributed over the silica, whereas the solution was rapidly soaked in the pores. The resultant paste was shaken for 1 min. on a gyratory shaker at 600 rpm, in order to obtain a homogeneous mass with smooth surface, covered by a liquid film of 1-3 mm. After closing the dish with a stainless steel lid, the paste was heated without further mixing or moving for 48 hours in a drying oven at 60° C. yielding 49.6 g of moist composite.

Subsequently, 41.3 g of this still wet paste were washed on a frit with five times 25 ml of water. Then the composite cake was suspended in 31.6 ml of 10% sulphuric acid and treated under smooth shaking over two hours at ambient temperature, in order to hydrolyse unreacted epoxy groups. Finally the product was washed on a frit with once more five times 25 ml of water and then stored in 20% ethanol/water.

### Reference Example 1

### (Preparation of a Cross-Linked Polyvinylamine Gel)

In order to check the reaction without support material, 3 ml of the polymer-cross-linking agent solution of Example 1 was heated for 24 hours at 50° C. After six hours the gelation was visible. After 24 hours one piece of a transparent solid elastic gel was obtained.

### Example 1a

### Preparation of a Composite Adsorbent Using a Small Particle Size Support Material.

1 ml (935 mg) of hexane diol diclycidylether (Mw 230.2, d=1.07 g/ml) cross-linker were shaken with 59 ml water, forming a homogeneous emulsion. This cross-linker solution was added to 21 ml of an aqueous solution of poly(vinylformamid-co-polyvinylamin) (Lupamin 45-70, raw and untreated).

After mixing, a pH of 10 was adjusted with 0.5 M NaOH. 25 g of Silica Eurosil Bioselect 300-5, 5 μm, dry powder, were sedimented into a flat bottom stainless steel dish with 12 cm diameter. The bed height was about 15 mm. 46 g of the polymer-cross-linker solution were added and equally distributed over the silica, whereas the solution was soaked in the pores, forming a viscous, mucous mass. After adding of a 1.5 ml portion of the polymer-cross-linker solution and finally of 4 ml diluted polymer (1 ml of poly(vinylformamide-co-polyvinylamine) diluted with 3 ml of water) the suspension became smooth and homogeneous. The resultant paste was covered by a liquid film of about 1 mm height. After closing the dish with a stainless steel lid, the batch was heated without further mixing or moving for 21 hours in a drying oven at 65° C. yielding 72 g of moist composite.

Subsequently, this paste was diluted with distilled water to a volume of 150 ml, and the resultant suspension was pumped into a 250×20 mm HPLC column, using a preparative HPLC pump. The packed composite bed was then washed with 250 ml of water. In order to hydrolyse unreacted epoxy groups, 100 ml of 2 n hydrochloric acid were pumped into the column and left there over two hours at ambient temperature. As the back pressure increased during this step and the subsequent rinsing with water, the packed composite was finally washed with 300 ml of ethanol, whereas the pressure dropped to 5 bars at a flow rate of 10 ml/min. The product was removed from the column and dried at ambient temperature. The nitrogen content was determined to 1.18%, and the carbon content to 2.99%.

### Example 2

Preparation of a Filter Medium Coating a Spun Web Material with a Cross-Linked Poly Amine.

2 ml of hexanediol diglycidylether, Ipox RD 18, were mixed with 56 ml water, generating an emulsion. 20 ml of poly(vinylamin) Lupamin 90-95, solution in water, polymer content 62 g/l, were added. The emulsion became homogeneous after shaking. The pH was adjusted to 12, adding 4 ml of 1 N sodium hydroxide solution in five portions. Finally the emulsion was diluted with 160 ml water. The total reagent volume was 240 ml.

A sheet of 15 cm×10.5 cm (3.78 g) of the fabric PBS 290 S was submerged in 120 ml of the above reagent solution, and wrung out well after complete wetting. This procedure was repeated. Subsequently the excess reagent solution was removed on a sieve using a stainless steel roller.

After drying for 20 min under a infrared lamp, the coated sheet was heated during 24 hours at 60° C. in a drying cabinet.

The initial mass of the PBS 290 S sheet was 3.78 g, the final mass of the coated sheet was 4.15 g. The mass increase was thus 9.9%.

### Example 2a

The product of Example 2 was treated with 0.5 N hydrochloric acid, two times submerging and wringing the material. After washing three times with 300 ml water, wringing out, and drying at 60° C. for 24 hours the weight had increased by another 170 mg.

### Example 3

### Spontaneous Cross-Linking of Poly Amine and Citric Acid in Solution.

An aqueous solution of 12 ml (8.6 mmol monomer units) poly(vinylamin) Lupamin 90-95 (polymer content 31 g/l) was mixed with six times one ml (510 μmol) of an aqueous citric acid solution (85 mM). Immediately a voluminous white precipitate was formed, not completely soluble even under vigorous shaking and stirring during 20 min. While shaking continued on a gyration shaker, a white suspension remained after 30 min.

### Example 4

Stabile Gel Formed at High Temperature after Contacting the Cationic Polymer Solution with the Solid Anionic Cross-Linker.

One ml (170 μmol) of an aqueous citric acid solution (170 mM) was evaporated and dried on a watch glass at 150° C. for one hour. The solid residue was transparent.

One ml (480 μmol monomer content) of a poly(vinylamin) Lupamin 90-95 solution (20.7 g/l, pH 9) was added, whereas this liquid layer initially covered the solid layer of citric acid. This composition was heated at 150° C., merging the solid and liquid phase. A brittle yellowish residue was formed after the evaporation of the water.

After cooling, two ml of water were added, whereas a voluminous non-soluble gel was formed within 20 min.

### Example 5

Two-Step Process for the Preparation of a Filter Medium, Coating a Fleece with a Cross-Linked Poly Amine.

Four sheets of a fabric LD 7260TW (29.6 cm×21.0 cm) were submerged for five minutes in 375 ml of a 170 mM solution of citric acid monohydrate, whereas the sheets were turned three times. The fleece was completely wetted.

After draining off excess solution using a stainless steel grate, the coated fleeces were dried for 20 min at 130° C. under reduced pressure (200 mbar) using a drying cabinet. The mass increase was 5% of the initial mass of the sheets.

A flat glass dish was filled with 150 ml of an aqueous poly(vinylamin) Lupamin 90-95 solution (20.7 g/l, pH 9) and one of the above sheets coated with citric acid was submerged in this polymer solution for 10 seconds, turned, and drained. This procedure was repeated. An about 1 mm thick, viscous layer of polymer solution remained on both surfaces of the sheet.

Using a drying cabinet the sheet was heated at 130° C. during 30 min.

After cooling to room temperature the sheet was submerged in 200 ml water, washed on both sides for two min with demineralised flowing water. After draining, the sheet was dried again for 30 min at 130° C. under reduced pressure (200 mbar).

The initial mass of the LD 7260TW sheet was 3.9 g, the final mass of the coated sheet was 4.4 g. The mass increase was thus 12.8%.

### Examples 6

Gels Obtained by Amide Formation at High Temperature, Starting with a Homogeneous Solution of an Amino Polymer and a Dicarboxylic Acid, and/or their Salts.

Examples 6a to 6e are relating to the mixing the amino polymer with succinic acid at temperatures between 20° C. and 22° C. and reacting the components at temperatures between 110° C. and 190° C.

### Polymer Solution A:

10 ml of an aqueous solution of poly(vinylformamid-co-vinylamin) in water (Lupamin 45-70) was diluted with 50 ml water. The pH was 10, due to the content of sodium hydroxide. The polymer concentration was 21.7 mg/ml, the monomer concentration thus approximately 425 mM (Mₘₒₙₒ 51 g/l).

### Cross-Linker Solution B:

An aqueous solution of 50 mM succinic acid was prepared (M=118), dissolving 590 mg of the succinic acid in 100 ml water (pH 3.5).

### Cross-Linker Solution C:

The cross-linker solution B was converted to the ammonium salt by dropwise titration with 7 N aqueous ammonia solution, until pH 8 was reached.

### Example 6a

4 ml (1.7 mmol monomer units) of this polymer solution A were stepwise mixed with four times 0.5 ml (100 μmol) of the cross-linker solution B. Under this condition, starting with the polymer solution of pH 10, the succinic acid was immediately converted to the sodium salt. The resultant solution remained clear, no precipitate was observed.

This solution was concentrated from 6 ml to 200 μl at 110° C. and 300 mbar. The remaining clear viscous suspension was dried and the residue was digested with 0.5 ml water and dried again, always at 110° C. This procedure was repeated three times. After wetting with water a solid gel was finally obtained, not soluble, but swelling.

### Example 6b

Before stepwise introducing 2 ml of the cross-linker solution B, 4 ml of this Polymer solution A were mixed with 50 μl portions of 15 M acetic acid, until a pH of 5 was reached, thus transferring the polymer in the acetate salt. The amino groups were protonated.

No precipitation occurred after contact with the succinic acid solution. After concentration this solution to 200 μl at 110° C. and 300 mbar, the drying procedure of Example 6a was carried out, yielding a transparent gel, not soluble, but swelling in water.

### Example 6c

4 ml of this polymer solution A were mixed with 50 μl portions of 15 M acetic acid until a pH of 4 was reached and then contacted with the succinic acid following the procedure of Example 6b. The same results were obtained as in Examples 6a and 6b.

### Example 6d

A solution of poly amine and succinic acid was prepared according to Example 6b, the total volume of 6 ml was concentrated at 190° C. until dryness and heated for further 15 min. After contacting with 0.5 ml water the brittle white residue formed a swelling gel.

### Example 6e

4 ml of the polymer solution A were mixed with 50 μl portions of 15 M acetic acid until a pH of 4 was reached. Four times 0.5 ml of the cross-linker solution C were added, whereas the solution remained clear. After four times drying at 110° C. and contacting with 0.5 ml water, a swelling gel was obtained.

### Example 7

### Preparation of a Filter Medium in a Wet-Laid Process Using a Sheet Former

2 g of a solid glass fiber mixture (60% B 39, 10% B 06, and 30% EC 06) were prepared and suspended under stirring in 250 ml of 1.2 mM aqueous hydrochloric acid. This suspension was filled into the vessel of a sheet former, and was immediately aspirated under vacuum through the frit on the bottom of the sheet former vessel. A thin, dense, and homogeneous fiber layer was formed on the top of the frit.

2.7 ml poly(ethylene glycol) diglycidyl ether, average Mₙ 500, were dissolved in 240 ml water. 10.25 ml of Lupamin 45-70, poly(vinylformamid-co-polyvinylamin) solution in water (c=130 g/l), were added, containing 1.33 g of said polymer. This solution was poured into the vessel on the top of the above fiber layer and aspirated after 10 min.

The fragile moist intermediate was removed from the frit. After treatment with a roller the weight was 20.8 g.

The reaction of the polymer and the cross-linker was performed by heating at 140° C. for 20 min. An 0.5 mm thin, mechanically stabile porous sheet was isolated. The dry weight was 2.3 g.

After incineration at 600° C. the weight decreased to 1.84 g, representing the glass fiber matrix. Accordingly was the mass of the cross-linked amino polymer 456 mg (19.8%).

### Fig. Embodiment 1.1

Composite Adsorbent of Example 1. Plot of the net elution volume Vₑ (μl) of methanol, ethylene glycol, and six pullulane standards with known different hydrodynamic radii (Rₕᵢ), versus Rₕᵢ.

The pore volume Vₚ of the adsorbents and the interstitial volume Vᵢ between the particles are determined by iSEC (diagram Vₑ), using a packed column of a 1 ml (50×5 mm) nominal resin volume. In the column, packed with the support material Davisil LC 250 and the various composite materials, total liquid volumes Vₜ=Vₑ (Vₑ is the net elution volume determined, when the extra column volume has been subtracted) between 965 μl and 998 μl have been measured, completely accessible for the smallest standard methanol. Interstitial volumes Vᵢ between the particles have been determined between 450 μl and 530 μl. The deviations in the particular volume fractions are due to small differences in the amount of packed material as well as in the packing density of the individual column. Standards with Rₕ>9 nm are not able to access the pores of the silica Davisil LC 250 and are eluting within the same volume after migrating solely after passing the interstitial volume Vᵢ of 449 μl. E.g. the total pore volume Vₚ of e.g. Davisil LC 250 silica in the column of Fig. Embodiment 1.1 is the difference of 998 μl-449 μl=549 μl. The calibrated pullulane standards are penetrating a volume fraction according to their particular hydrodynamic radius Rₕ. The volume ratios of the various composites are measured in the same way.

### Fig. Embodiment 1.2

Composite Adsorbent of Example 1. Plot of the distribution coefficient (Kₐᵥ value, i.e. pore volume distribution fraction, see Methods; Kₐᵥ is equivalent to the fraction of pore volume available for an individual substance) versus the hydrodynamic radius Rₕᵢ of the same test substances as in Fig. Embodiment 1.1.

The distribution coefficient Kₐᵥ is defined as the pore volume fraction Vₑₙ available for the particular molecular standard n above a certain pore diameter, i.e., Kₐᵥ=Vₑₙ−Vᵢ/Vₑ−Vᵢ. The upper iSEC curve (Silica 250) shows the pore size distribution of the support material Davisil LC 250, with an exclusion limit at Rₕ=9 nm and an accessible pore volume fraction Kₐᵥ of 0.36 (36% of the total pore volume is given between 4 nm and 9 nm hydrodynamic radius of the polymer standard) at a Rₕ of 4 nm. That means that 36% of the pore volume is accessible for a molecule with a Rₕ of 4 nm.

The three lower curves show the porosity of the embodiment of Example 1 obtained with repetitive runs. After the immobilization of the polymer only <5% (Kₐᵥ=0.05) of the pores exhibit a value of 4 nm or greater.

This is the physical proof for filled/full or occupied pores under the conditions of use, with respect to the accessibility for a molecule of particular diameter: Whereas in the starting material Davisil LC 250 more than 36% of pores are found in the range between 4 and 9 nm, more than 30% of the corresponding pore volume is absent in the product of Example 1 after cross-linking of the functional polymer thus generating the polymeric mesh. This is obviously due to the space occupation and partitioning of just this volume by the polymer network.

With other words: >30% of the pore volume of the Davisil LC 250 between 4 nm and 9 nm, which initially represented >36% of the total pore volume, has disappeared, because the pores of this size have been occupied by the polymeric mesh, exhibiting significantly smaller pores. All of the smaller support pores are containing the polymeric mesh, too. Accordingly the porosity of the composite is established by the internal pores of the polymeric mesh (like a small sponge) in its swollen state at a pH of 6. The low molecular weight standard methanol, however, enters the entire pore volume of the support material as well as the entire pore volume of the composite. Hence, the slope of the composite porosity curve is significantly steeper than the slope of the Davisil LC 250 curve.

Provided that only the walls of the Davisil LC 250 would have been coated, the Kₐᵥ curve of the composite would be anticipated parallel to the Davisil LC 250 curve, at least in the range between Rₕ of 4 nm to 9 nm, because there would always a gap be left behind in the center of each pore.

1. A method for removing a contaminant from a gas contaminated with one or more of the following contaminants: protein, glycoprotein, lipoprotein, RNA, DNA, oligonucleotide, oligosaccharide, polysaccharide, lipo poly(saccharides), other lipids, phenolic compound, characterized in that the contaminated gas is contacted with at least one filter medium or a filter element comprising the at least one filter medium or with a filter arrangement comprising the filter element, the at least one filter medium comprising at least one cross-linked functional polymer immobilized on a support.

2. A method for removing a contaminant from a liquid or a gas contaminated with one or more of the following contaminants, respectively: protein, glycoprotein, lipoprotein, RNA, DNA, oligonucleotide, oligosaccharide, polysaccharide, lipo poly(saccharide), other lipid, fat, phenolic compound, metal, metal cations, and degradation products of plants, animal tissue, algae, microorganisms, characterized in that the contaminated liquid or gas is contacted with at least one filter medium or a filter element comprising the at least one filter medium or with a filter arrangement comprising the filter element, the at least one filter medium comprising at least one cross-linked functional polymer immobilized on a support, wherein the at least one filter medium is manufactured in a wet-laid process,

3. The method of claim 1, wherein said one or more contaminants are comprised in an aerosol or in dust.

4. The method of claim 1, wherein said at least one cross-linked functional polymer comprises at least one basic residue or at least one acidic residue, preferably wherein the at least one basic group comprises at least one primary or secondary amino group and the at least one acidic residue comprises at least one carboxylic group.

5. (canceled)

6. The method of claim 1, wherein the contaminated liquid or gas is contacted first with the at least one filter medium comprising at least one cross-linked functional polymer immobilized on a solid support, and subsequently with a filter medium not comprising a cross-linked functional polymer immobilized on a support; or
wherein the contaminated liquid or gas is contacted first with a filter medium not comprising a cross-linked functional polymer immobilized on a support, and subsequently with the at least one filter medium comprising at least one cross-linked functional polymer immobilized on a solid support.

7. The method of claim 6, wherein the at least one functional polymer of the filter medium comprises at least one basic residue or at least one acidic residue.

8. The method of claim 1, wherein the contaminated liquid or gas is contacted first with a combination of at least two filter media comprising a cross-linked functional polymer immobilized on a solid support, respectively, wherein the cross-linked functional polymers are the same or are different, and subsequently with a filter medium not comprising a cross-linked functional polymer immobilized on a support; or
wherein the contaminated liquid or gas is contacted first with a filter medium not comprising a cross-linked functional polymer immobilized on a support, and subsequently with a combination of at least two filter media comprising a cross-linked functional polymer immobilized on a solid support, respectively, wherein the cross-linked functional polymers are the same or are different.

9. The method of claim 8, wherein one of said at least two functional polymers comprises at least one basic residue, and the other functional polymer comprises at least one acidic residue.

10. A filter medium comprising fibers or particles or fibers and particles, wherein said fibers and/or particles are connected with one another by a cross-linked functional polymer.

11. The filter medium of claim 10, wherein the fiber length ranges from 20 μm to 60 mm; or wherein the fiber diameter ranges from 0.1 μm to 100 μm; or
wherein the fiber length ranges from 20 μm to 60 mm and the fiber diameter ranges from 0.1 μm to 100 μm; or
wherein the particle sizes range from 0.5 nm to 500 μm; or
wherein the fibers are made from glass, polyester or poly(vinylalcohol); or
wherein the particles are made from glass, silica, alumina, or activated carbon; or
wherein the fibers are made from glass, polyester or poly(vinylalcohol) and the particles are made from glass, silica, alumina, or activated carbon.

12. (canceled)

13. (canceled)

14. The filter medium of claim 10, wherein the cross-linked functional polymer comprises at least one basic residue or at least one acidic residue, preferably wherein the at least one basic residue is a primary or a secondary amino group or wherein the at least one acidic residue is a carboxylic group.

15. (canceled)

16. (canceled)

17. (canceled)

18. The filter medium of claim 10, wherein the cross-linked functional polymer forms a polymeric mesh, preferably wherein the polymeric mesh has a mean pore radius from 1 nm to less than 20 nm; or
wherein the cross-linked functional polymer comprises a functional polymer and a cross-linker covalently bonded to one another via at least one group selected from amino, amide, ester and thioester; or
wherein the filter medium exhibits a web with a mean web diameter of from 50 nm to 1 mm, wherein the web is defined as the space between to the interconnected particles or fibers.

19. (canceled)

20. (canceled)

21. (canceled)

22. A combination of at least two filter media, wherein one of the at least two filter media comprises a cross-linked functional polymer as defined in claim 10, and the other filter medium does not comprise a cross-linked functional polymer as defined in claim 10.

23. A wet-laid process for the production of a filter medium as defined in claim 10,
comprising steps (i) to (v):
(i) suspending fibers or particles or fibers and particles in a liquid,
(ii) precipitating and optionally aspirating a layer comprising said fibers or particles or fibers and particles on a sieve or a frit,
(iii) contacting the layer formed in step (ii) with a reagent solution or reagent suspension comprising at least one functional polymer and at least one cross-linker,
(iv) optionally aspirating excess liquid of the layer formed in step (iii) through the sieve or frit,
(v) drying and supplying thermal, oscillation, vibrational, or radiation energy, preferably heating the layer formed in step (iii) or (iv);
or
(i) suspending fibers or particles or fibers and particles in a liquid, and further dissolving or suspending at least one functional polymer in the liquid,
(ii) precipitating and optionally aspirating a layer comprising said fibers or particles or fibers and particles, and said at least one functional polymer on a sieve or a frit,
(iii) contacting the layer formed in step (i) with a solution or suspension comprising at least one cross-linker,
(iv) optionally aspirating excess liquid of the layer formed in step (iii) through the sieve or frit,
(v) drying and supplying thermal, oscillation, vibrational, or radiation energy, preferably heating the layer formed in step (iii) or (iv);
or
(i) suspending fibers or particles or fibers and particles in a liquid, and further dissolving or suspending at least one cross-linker in the liquid,
(ii) precipitating and optionally aspirating a layer comprising said fibers or particles or fibers and particles, and said at least one cross-linker on a sieve or a frit,
(iii) contacting the layer formed in step (i) with a solution or suspension comprising at least one functional polymer,
(iv) optionally aspirating excess liquid of the layer formed in step (iii) through the sieve or frit,
(v) drying and supplying thermal, oscillation, vibrational, or radiation energy, preferably heating the layer formed in step (iii) or (iv);
or comprising steps (i) to (iv)
(i) suspending fibers or particles or fibers and particles in a liquid, and further dissolving or suspending at least one functional polymer and at least one cross-linker in the liquid,
(ii) precipitating and optionally aspirating a layer comprising said fibers or particles or fibers and particles, and said at least one functional polymer and said at least one cross-linker on a sieve or a frit,
(iii) optionally aspirating excess liquid of the layer formed in step (ii) through the sieve or frit,
(iv) drying and supplying thermal, oscillation, vibrational, or radiation energy, preferably heating the layer formed in step (ii) or (iii);

24. The wet-laid process of claim 23, further comprising
reacting the at least one functional polymer in form of a salt of a cationic functional polymer with the at least one cross-linker in form of an anionic cross-linker; or reacting the at least one functional polymer in form of a salt of an anionic functional polymer with at least one cross-linker in form of a cationic cross-linker;
or
reacting the at least one functional polymer in form of a cationic functional polymer with the at least one cross-linker in form of a salt of an anionic cross-linker, or reacting the at least one functional polymer in form of an anionic functional polymer with at least one cross-linker in form of a salt of a cationic cross-linker; or
reacting the at least one functional polymer in form of a salt of a cationic functional polymer with the at least one cross-linker in form of a salt of an anionic cross-linker; or reacting the at least one functional polymer in form of a salt of an anionic functional polymer with at least one cross-linker in form of a salt of a cationic cross-linker.

25. A process for the preparation of a polymeric mesh, wherein
at least one salt of a cationic polymer is reacted with at least one anionic cross-linker;
or
at least one salt of an anionic polymeric is reacted with a cationic cross-linker;
or
wherein at least one cationic polymer is reacted with at least one salt of an anionic cross-linker; or
at least one anionic polymer is reacted with at least one salt of a cationic cross-linker;
or
at least one salt of a cationic polymer is reacted with at least one salt of an anionic cross-linker; or
a salt of at least anionic polymer is reacted with at least one salt of a cationic cross-linker,
the process comprising steps (i) to (iv), respectively:
(i) mixing and dissolving the components in a solvent,
(ii) supplying thermal, oscillation, vibrational, or radiation energy, preferably heating the mixture,
(iii) optionally evaporating at least a part of the solvents, and
(iv) isolating the solid polymeric mesh.

26. The process of claim 25, wherein step (ii) is performed in presence of a support having a surface such to immobilize the polymeric mesh on the surface of the support, yielding a filter medium.

27. A polymeric mesh, comprising
the reaction product of at least one salt of a cationic polymer with at least one anionic cross-linker; or
at least one salt of an anionic polymeric with a cationic cross-linker;
or
the reaction product of at least one cationic polymer with at least one salt of an anionic cross-linker; or
at least one anionic polymer with at least one salt of a cationic cross-linker;
or
the reaction product of at least one salt of a cationic polymer with at least one salt of an anionic cross-linker; or
a salt of at least anionic polymer with at least one salt of a cationic cross-linker.

28. The filter medium comprising a polymeric mesh as defined in claim 27 and a support having a surface, preferably wherein the immobilized polymeric mesh is obtained by a process wherein
at least one salt of a cationic polymer is reacted with at least one anionic cross-linker; or
at least one salt of an anionic polymeric is reacted with a cationic cross-linker;
or
wherein at least one cationic polymer is reacted with at least one salt of an anionic cross-linker; or
at least one anionic polymer is reacted with at least one salt of a cationic cross-linker;
or
at least one salt of a cationic polymer is reacted with at least one salt of an anionic cross-linker; or
a salt of at least anionic polymer is reacted with at least one salt of a cationic cross-linker,
the process comprising steps (i) to (iv), respectively:
(i) mixing and dissolving the components in a solvent,
(ii) supplying thermal, oscillation, vibrational, or radiation energy, preferably heating the mixture,
(iii) optionally evaporating at least a part of the solvents, and
(iv) isolating the solid polymeric mesh; and
wherein step (ii) is performed in presence of a support having a surface such to immobilize the polymeric mesh on the surface of the support, yielding a filter medium.

29. A process for the production of a filter medium comprising a cross-linked functional polymer, comprising steps (i) to (vi):
(i) providing a support material,
(ii) contacting said support material with a solution or suspension of at least one cationic or anionic functional polymer or a salt thereof, respectively, in a solvent,
(iii) evaporating solvent;
(iv) contacting the support material comprising the at least one cationic or anionic functional polymer or a salt thereof obtained in step (iii) with a solution or suspension of at least one anionic cross-linker or a salt thereof in a solvent provided the at least one functional polymer is cationic, or with a solution or suspension of at least cationic cross-linker or a salt thereof in a solvent provided the at least one functional polymer is anionic;
(v) supplying thermal, oscillation, vibrational, or radiation energy, preferably heating the product of step (iv); and
(vi) optionally evaporating the solvent and drying the filter medium formed in step (v);
or
(i) providing a support material;
(ii) contacting said support material with a solution or suspension of at least one anionic or cationic cross-linker or a salt thereof, respectively, in a solvent;
(iii) evaporating solvent;
(iv) contacting the support material comprising the at least one anionic or cationic cross-linker or a salt thereof obtained in step (iii) with a solution or suspension of at least one cationic functional polymer or a salt thereof in a solvent provided the at least one cross-linker is anionic, or with a solution or suspension of at least one anionic functional polymer or a salt thereof in a solvent provided the at least one cross-linker is cationic;
(v) supplying thermal, oscillation, vibrational, or radiation energy, preferably heating the product of step (iv); and
(vi) optionally evaporating the solvent and drying the filter medium formed in step (v).

30. The process of claim 29, wherein the at least one functional polymer is a cationic polymer, and the cross-linker is an at least bivalent ester or thioester; or
wherein the at least one functional polymer comprises at least one thiol or hydroxyl group, and the at least one cross-linker is an at least bivalent carboxylic acid, ester or thioester; or
wherein the at least one functional polymer comprises at least two carboxy, ester or thioester groups, and the at least one cross-linker is an at least bivalent primary or secondary amine, an amino alcohol, or an at least bivalent alcohol; of
wherein neither the at least one functional polymer nor the at least one cross-linker are active or are activated.

31. (canceled)

32. (canceled)

33. The process of claim 29, wherein the at least one cross-linker is a second functional polymer.

34. The process of claim 33, wherein the at least one functional polymer is a basic polymer and the second polymer is poly(methacrylic ester), a poly(acrylic ester), or a poly(vinylacetate); or
Wherein the at least one functional polymer is a poly(methacrylic ester), a poly(acrylic ester), or a poly(vinylacetate), and the second functional polymer is a polyamine.

35. The process of claim 34, wherein the at least one polymer comprises at least two primary or secondary amino groups or is a polyamine.

36. (canceled)

37. The process of claim 23, wherein the heating in step (iv) or step (v) is in a temperature range of from 80 to 250° C.; or
claims 29 to 36, wherein the heating in step (v) is in a temperature range of from 80 to 250° C.: or
claims 25 and 26, wherein the heating in step (ii) is in a temperature range of from 80 to 250° C.; and
preferably wherein the heating is performed for less than 10 seconds.

38. (canceled)

39. (canceled)

40. The filter element comprising at least one filter medium as defined in claim 10.

41. The filter element of claim 40, comprising at least one additional device, component, layer, building block or segment; or comprising a further filter medium, preferably wherein the further filter medium is not a filter medium as defined in claim 10.

42. (canceled)

43. (canceled)

44. The filter arrangement comprising at least one filter element as defined in claim 40.
